(19) United States
(12) Patent Application Publication
(10) Pub. No.: US 2025/0139487 A1
(43) Pub. Date: May 1, 2025

(54) DIFFERENTIABLE GENERATIVE MODELLING USING A HYBRID COMPUTER INCLUDING A QUANTUM PROCESSOR

(71) Applicant: PASQAL NETHERLANDS B.V., Amsterdam (NL)

(72) Inventors: Vincent Emanuel Elfving, Amsterdam (NL); Oleksandr Kyriienko, Amsterdam (NL)

(21) Appl. No.: 18/835,831

(22) PCT Filed: Jul. 2, 2023
(86) PCT No.: PCT/EP2023/052998

§ 371 Date: Aug. 5, 2024

(30) Foreign Application Priority Data
Feb. 7, 2022 (EP) 22155513.9

(51) Int. Cl. G06N 10/60; G06N 10/20

(52) U.S. Cl. CPC G06N 10/60; G06N 10/20

(57) ABSTRACT

Disclosed is an approach for learning probability distributions as differentiable quantum circuits (DQC) that enable efficient quantum generative modelling (QGM) and synthetic data generation. A method includes training of a differentiable quantum circuits (DCQ) based model, where data is encoded in a latent space with a phase feature map, followed by a variational quantum circuit. The trained model is then mapped to the bit basis using a fixed unitary transformation, coinciding with a quantum Fourier transform circuit in the simplest case. This allows fast sampling from parametrized distributions using a single-shot readout. Simplified latent space training provides models that are automatically differentiable. Samples from propagated stochastic differential equations (SDEs) can be accessed by solving a stationary Fokker-Planck equation and time-dependent Kolmogorov backward equation on a quantum computer. A route to multidimensional generative modelling is opened with qubit registers explicitly correlated via a (fixed) entangling layer.

### TECHNICAL FIELD

The disclosure relates to quantum generative modelling, in particular, though not exclusively, to methods and systems for differentiable generative modelling using a quantum a hybrid computer including a quantum processor and computer program products for such hybrid computers.

### BACKGROUND

Quantum computers are well-suited for quantum chemistry applications, as they are naturally suitable for the simulation of certain quantum processes. At the same time, quantum computers are not directly suited for all computational problems, and can be seen as specialized machines (akin to GPUs), that need to be tailored to the problem at hand. Designing these machines and their operational schedule is crucial for solving problems in quantum computers faster than any available classical methods. This remains true for tasks and applications in differential calculus.

In principle, the information content of a N-qubit register can be described by 2\hat{ }N classical complex numbers. A ‘quantum circuit’ is a set of instructions sent by a classical computer to a quantum computer to execute certain ‘gate operations’ or ‘unitaries’, which in practice involve a sequence of operations on the quantum system such as microwave or optical pulses.

In general, compressing 2^{N}-dimensional data into an N-qubit register is beneficial due to exponential memory savings. However, several problems arise. First, creating an exponentially compressed state from a vector of constants is a serious problem, that requires sophisticated techniques like quantum random access memory (QRAM) and may require exponentially many gate operations for preparing a general state, resulting in an exponential scaling of the algorithmic runtime.

Current quantum devices are prone to noise and are not suited for large depth quantum circuits. However, the Hilbert space of these devices increases exponentially with the number of qubits, providing advantage over classical methods for certain problems. Quantum processors with about ˜100 qubits may offer computational power inaccessible to classical computers. This corresponds to Noisy Intermediate Scale Quantum (NISQ) processors, that are special purpose devices that need to be co-designed with a problem in mind.

A particularly useful approach in this setting is to use variational quantum algorithms (VQA). Initially proposed for chemistry under the name of variational quantum eigensolver (VQE), this approach queries a quantum computer to prepare low energy states on a quantum devices, but guiding the optimization loops using a classical computer. This strategy has allowed to perform quantum calculations with relatively noisy devices, allowing for numerous advances, unmatched by current large-depth protocols. This has triggered the attention to generic VQA's, finding applications in many application areas including data science, quantum simulation and more recently also in quantum generative modelling.

Quantum generative modelling (QGM) aims to exploit trainable circuits that can prepare distributions as quantum states. Being a subject of emerging quantum machine learning (QML), QGM utilizes the Born rule inherent to quantum mechanics. The goal is to represent a parametrized probability distribution p_{θ}(x) as a probability to measure a bit string x from a variational state parametrized by a vector gate parameters θ. By using so-called quantum circuit Born machines (QCBMs) models can be learned directly from samples of a target distribution using various loss functions. Here, directly means that a sample can be determined directly from a measured wavefunction, so that for one sample in principle only one quantum measurement is needed. Another approach is based on so-called quantum generative adversarial networks (QGANs), where a training schedule corresponds to the minimax game.

While making a step towards sampling-based advantage on quantum computers, current QGM performance is largely limited. First, QCBM and QGAN-based distribution generators are difficult to train as they require matching [symbol] (2^{N}) amplitudes for N-qubit registers and finding corresponding state for some vector θ. Second, the QCBM architecture is not automatically differentiable with respect to variable x, and QGAN differentiation leads to an ill-defined loss landscape. Thus, currently QML has limited application for applications such as solving stochastic differential equations (SDE). More generally, current quantum algorithmic solutions to generative modelling, current methods rely on computationally-expensive amplitude encoding schemes, complex or deep quantum circuits, or other incompatibilities with realistic NISQ hardware devices available today and in the expected near future.

Hence, from the above, it follows that there is therefore a need in the art for improved methods and systems for generative modelling using quantum computers. In particular, there is a need in the art for improved methods and systems for training differentiable generative models and to generate sets of samples from such models, as well as providing a framework that is compatible with near-term quantum hardware with limited circuit depth, as well as extensibility to fault-tolerant hardware.

### SUMMARY

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. Additionally, the Instructions may be executed by any type of processors, including but not limited to one or more digital signal processors (DSPs), general purpose microprocessors, application specific integrated circuits (ASICs), field programmable logic arrays (FP-GAs), or other equivalent integrated or discrete logic circuitry.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

This disclosure relates to methods and systems for learning probability distributions as differentiable quantum circuits (DQC) that enable efficient quantum generative modelling (QGM) and synthetic data generation (e.g., time-series data). Contrary to existing QGM approaches, the methods in this disclosure perform training of a DQC-based model, where data is encoded in a latent space with a phase feature map, followed by a variational quantum circuit. The trained model is then mapped to a bit basis using a fixed unitary transformation. In the simplest case, this may coincide with a quantum Fourier transform circuit. This allows fast sampling from parametrized probability distributions using a single-shot readout.

Simplified latent space training may provide models that are automatically differentiable. Moreover, samples from propagated stochastic differential equations (SDEs) can be accessed by solving a stationary Fokker-Planck equation and time-dependent Kolmogorov backward equation on a quantum computer. Finally, this approach opens a route to multidimensional generative modelling with qubit registers explicitly correlated via a (fixed) entangling layer. In this case, quantum computers can offer advantages as efficient samplers, which can perform complex inverse transform sampling enabled by fundamental laws of quantum mechanics. Thus, specific hardware with fast (optical) readout for sampling can provide an edge over existing quantum solutions. This disclosure also introduces a phase feature map, analyses its properties, and describes frequency-taming techniques that include qubit-wise training and feature map sparsification.

A method for efficiently training a differentiable quantum generative model, referred to as DQGM, is described. This method separates training and sampling stages. Consequently, circuits may be trained in the latent space as a feature-map-encoded differentiable circuit, while the optimized circuit may be sampled with an additional (fixed) basis transformation. The method may use a phase feature map. The method may further use frequency-taming techniques that include qubit-wise training and feature map sparsification. As is shown by a benchmark against QCBM, using numerical simulations, samples from propagated stochastic differential equations can be accessed by solving a Fokker-Planck equation on a quantum computer. Embodiments of the method also allow multidimensional generative modelling with qubit registers explicitly correlated via a (fixed) entangling layer. In this case, quantum computers can offer advantage over classical implementations as efficient samplers, which perform complex inverse transform sampling enabled by fundamental laws of quantum mechanics.

It is an objective of the embodiments in this disclosure to reduce or eliminate at least part of the drawbacks known in the prior art.

In an aspect, the invention may relate to a method for sampling a generative model using a hybrid data processing system comprising a classical computer and a special purpose processor, e.g., a quantum processor. The quantum processor can be a real or a simulated quantum processor. The generative model is associated with a probability density function, PDF, in one or more dimensions. The probability density function is parameterized by a variable, which may be a higher-dimensional variable. Optionally, the probability density function is also parameterized by one or more further parameters, such as time. The method comprises receiving or determining, by the classical computer, a trained quantum neural network (QNN), the trained QNN being describable by a feature map for encoding the variable and a first parameterized quantum circuit, the trained QNN modelling the probability density function. The method further comprises executing, by the classical computer, a sampling process, the sampling process including generating, by the quantum processor, samples based on the modelled probability density function. The sampling process may use a quantum circuit that is describable by a second parameterized quantum circuit, the second parameterized quantum circuit comprising an inverse of the first parametrized quantum circuit of the trained QNN, and a unitary transformation, preferably a quantum Fourier transform circuit, associated with the feature map for encoding the variable. The sampling process may comprise a measurement in a computational basis associated with the feature map, yielding bitstrings as measurement results, each bitstring representing a sample from the modelled stochastic process.

In an embodiment, the generation of samples by the quantum processor may comprise: preparing the quantum register of the quantum processor in an initial state, applying the second parameterized quantum circuit to the quantum register, the second parameterized quantum circuit comprising an inverse of the first parametrized quantum circuit of the trained QNN; applying a unitary transformation, preferably a quantum Fourier transform circuit, associated with the feature map used in the training process; and measuring the quantum register in a computational basis associated with the feature map, yielding bitstrings as measurement results, each bitstring representing a sample based on the modelled probability density function.

The feature map may encode the (possibly higher-dimensional) variable in the phase space or latent space. The samples may be based on, or follow, the probability density function in the sense that a normalised histogram of the generated samples approximates the modelled probability density function for a sufficiently large number of generated samples.

In an embodiment, the method further comprises a training process. In such an embodiment, the method comprises receiving, by the classical computer, a set of information about a distribution function associated with the probability density function, the set of information including measurements of a stochastic process and/or an explicit or implicit functional description of the distribution function. The distribution function may underlie a stochastic process, and the set of information may include measurements of the stochastic process and/or an explicit or implicit functional description of the distribution function. In this embodiment, the method further comprises executing, by the classical computer, a training process for training the QNN, to model the probability density function using training data based on the set of information and a loss function, the training process comprising execution of the QNN by the quantum processor. The execution of the QNN may comprise preparing a quantum register of the quantum processor in the initial state, applying a quantum circuit defining the quantum feature map to the quantum register; applying the first parameterized quantum circuit associated with variational parameters to the quantum register, and measuring a cost function value on the quantum register, the cost function value representing the output of the QNN.

The set of information may explicitly or implicitly define or otherwise represent a distribution function, which itself may be known or unknown. For example, the set of information may comprise an (analytical) functional description of the distribution function (also known as explicit generative modelling), and/or one or more (possibly differential) equations defining or constraining a distribution function (also known as implicit generative modelling). In such cases, the training process may be seen as finding a numerical solution that fits the functional description and/or solves the differential equations. Alternatively, a set of measurements obtained from a stochastic process; in that case, the training process may be seen as finding a distribution function that has a high probability of providing the measurements. Combinations are also possible, e.g., a set of measurement data combined with differential equations putting constraints on one or more variables or informing boundary conditions.

In an embodiment, the method may comprise receiving by the classical computer a set of information about a stochastic process, including samples (data) and/or parametric analytical function or parametric (implicit) distribution function, preferably the distribution function defining a probability density function (PDF) in one or more dimensions, parametrized by a variable x and, optionally, one or more further parameters, such as time. The method may further comprise executing by the classical computer a training process for training a quantum neural network (QNN) to model a probability density function, the training data including measurements of the stochastic process and/or functional descriptions of the distribution, the QNN including a feature map for encoding a variable x of the distribution function, a variational circuit associated with variational parameters, and a cost function for determining the output of the QNN. The method may further comprise executing by the classical computer a sampling process using a parametrized quantum circuit for the one or more parametric dimensions, the sampling process including generating samples of the modelled stochastic process, the parameterized quantum circuit comprising the inverse of the variational circuit of the trained QNN, a unitary transformation, preferably a quantum Fourier transform circuit, associated with the type of feature map used in the training phase, and a quantum register, wherein the quantum register is measured in the computational basis, yielding bitstrings as measurement results, each bitstring representing a sample from the modelled stochastic process.

In an embodiment, the distribution function describes the outcomes of the stochastic process modelled by a Stochastic Differential Equation (SDE) in one or more dimensions. The SDE can be, e.g., a reverse-time SDE, or a backward SDE, or a forward SDE, or a reverse-time backward SDE.

In an embodiment, the training process includes minimizing a loss function on the basis of a measured expectation value of the cost function by variationally tuning the variational parameters and repeating execution of quantum gate operations associated with the variational circuit and measurement of the output of the quantum computer as an expectation value of the cost function until convergence criteria are met. The training process may comprise repeated execution of the QNN as described above. The expectation value of the cost function may define a trial function.

In an embodiment, the training process includes: receiving or determining, by the classical computer, a formulation of quantum circuits representing the probability density function; executing, by the quantum processor, the QNN for a set of points zⱼ in the variable space x of the probability density function; receiving, by the classical computer, in response to the execution of the QNN, quantum hardware measurement data; and determining, by the classical computer, based on the quantum hardware measurement data and the loss function, if the quantum hardware measurement data form an accurate representation of the probability density function, given the set of information.

In an embodiment, the QNN is parametrized by at least one continuous-variable x associated with the stochastic process through the probability density function, and the QNN includes one or more function circuits for determining one or more trial functions values p(xⱼ) around one more points xⱼ and one or more differential function circuits for determining one or more trial derivative values, preferably one or more first order trial derivatives and one or more second order trial derivatives, around the one or more points xⱼ.

In an embodiment, the training process includes solving a stationary or non-stationary Fokker-Planck equation, FPE, associated with the stochastic process, based on differentiable quantum circuits, DQCs, the differentiable quantum circuits including a first feature map quantum circuit which is a function of a differentiable variable x of the FPE, and a quantum circuit representing a variational ansatz.

In an embodiment, the determining if the quantum hardware measurement data forms a representative description of the probability density function is further based on one or more differential constraints associated with one or more SDEs, boundary conditions or probability density function properties, including, e.g., stationarity, convexity, tail shapes, etc.

In an embodiment, executing the quantum circuits includes: translating each of the quantum circuits into a sequence of signals and using the sequence of signals to operate qubits of the quantum processor; and/or, wherein receiving hardware measurement data includes: applying a read-out signal to qubits of the quantum processor and in response to the read-out signal measuring quantum hardware measurement data.

In an embodiment, execution of the first parametrized quantum circuit by the quantum processor comprises generation of a first sequence of pulses, each pulse in the first sequence of pulses having an amplitude and a phase, and wherein execution of the inverse of the first parametrized quantum circuit by the quantum processor comprises generation of a second sequence of pulses, the second sequence of pulses being obtainable by time-reversing the first sequence of pulses and inverting the amplitude or phase of the pulses.

In an embodiment, the quantum processor executing the quantum neural network for modelling the probability density function includes a gate-based qubit device, a digital/analog quantum device, a neutral-atom-based quantum device, an optical qubit device, and/or a gaussian boson sampling device.

In an embodiment, after the training process has been completed, the sampling process starts, the sampling process including: formulating a sampling circuit based on the trained parameters and the second parametrized quantum circuit; the sampling circuit being executed on the quantum processor for generating samples in the computational basis.

In an embodiment, the training process and sampling process are executed in different operational modes on the same quantum processor; or, are executed separately on distinct quantum processors.

In an embodiment, the stochastic process involves one or more than one stochastic variables, preferably, if the stochastic process involves more than one stochastic variable, the more than one stochastic variables being correlated; and wherein one or more quantum feature maps are used to map each stochastic variable to a quantum latent state space in the training process, and to distinct quantum registers in the sampling process.

In an embodiment, frequency taming and loading techniques are applied in a latent space representation of the probability density function on the quantum circuits, e.g., in the QNN. The frequency taming techniques may include one or more of the following components: qubit-wise learning, Fourier initialization, feature map sparsification, and multidimensional correlation.

In an embodiment, the feature map is differentiated using circuit differentiation rules, including parameter shift rules but preferably using optimized phase feature map differentiation.

In an embodiment, the trained QNN is maximized in an extremal-learning setting.

In an aspect, the disclosure may relate to a method for determining an inverse of a quantum circuit. The method comprises translating the quantum circuit into a first sequence of pulses, the sequence of pulses being configured to operate qubits of the quantum processor, each pulse in the first sequence of pulses having an amplitude and a phase. The method further comprises determining a second sequence of pulses, the second sequence of pulses being obtainable by time-reversing the first sequence of pulses and inverting each of the pulses in the first sequence of pulses. In this context, inverting a pulse may refer to determining a complex transpose of the pulse, e.g., inverting an amplitude or phase of the pulse. For example, if a pulse p is represented by p=exp(i\hat{χ}∫Ω(t)dt/2), then its inverse p⁻¹ may be denoted by, e.g., p⁻¹=exp (i\hat{χ}∫−Ω(t)dt/2), or p⁻¹=exp(i\hat{χ}(2π−∫Ω(t)dt)/2).

In an aspect, the disclosure may relate to a method for determining an inverse of a function using a hybrid data processing system, the hybrid data processing system comprising a classical computer and a quantum processor. The method may comprise receiving or determining, by the classical computer, a first plurality of quantum circuits associated with the function, preferably the first plurality of quantum circuits comprising a first quantum circuit for encoding an input variable and a second quantum circuit for encoding an output value associated with the input value. The output value of the function may be obtainable by execution of the first plurality of quantum circuits by the quantum processor, the execution comprising: preparing a quantum register of the quantum processor in an initial state; applying the first quantum circuit to the quantum register; applying the second quantum circuit to the quantum register; and measuring a cost function value on the quantum register, the cost function value representing the output of the function. The method may further comprise determining, by the classical computer, a second plurality of quantum circuits associated with the inverse of the function. Execution of the second plurality of quantum circuits by the quantum processor may comprise: preparing the quantum register of the quantum processor in the initial state; applying a third quantum circuit to the quantum register, the third quantum circuit comprising an inverse of the second quantum circuit; applying a unitary transformation, preferably a quantum Fourier transform circuit, associated with the first quantum circuit, and measuring the quantum register in a computational basis associated with the feature map, yielding bitstrings as measurement results, each bitstring representing an output of the inverted function.

In an aspect, this disclosure relates to a system for sampling a generative model associated with a probability density function, PDF, in one or more dimensions, the probability density function being parameterized by a possibly higher-dimensional variable and, optionally, one or more further parameters, such as time, preferably the probability density function being associated with one or more stochastic differential equations, SDEs, using a hybrid data processing system comprising a classical computer system and a special purpose processor, preferably a quantum processor, wherein the system is configured to perform the steps of: receiving or determining, by the classical computer, a trained quantum neural network, QNN, the trained QNN being describable by a feature map for encoding the variable and a first parameterized quantum circuit, the trained QNN modelling the probability density function; and executing, by the classical computer, a sampling process, the sampling process including generating, by the quantum processor, samples based on the modelled probability density function, the generation of samples comprising: preparing the quantum register of the quantum processor in an initial state; applying a second parameterized quantum circuit to the quantum register, the second parameterized quantum circuit comprising an inverse of the first parametrized quantum circuit of the trained QNN; applying a unitary transformation, preferably a quantum Fourier transform circuit, associated with the feature map, and measuring the quantum register in a computational basis associated with the feature map, yielding bitstrings as measurement results, each bitstring representing a sample based on the modelled probability density function.

In an embodiment, the system is configured to determine the trained QNN and wherein determining the trained QNN comprises: receiving, by the classical computer, a set of information about a distribution function associated with the probability density function, the set of information including measurements of a stochastic process and/or an explicit or implicit functional description of the distribution function; and executing, by the classical computer, a training process for training the QNN using training data based on the set of information and a loss function, the training process comprising execution of the QNN by the quantum processor, the execution of the QNN comprising: preparing a quantum register of the quantum processor in the initial state; applying a quantum circuit defining the quantum feature map to the quantum register; applying the first parameterized quantum circuit to the quantum register, the first parameterized quantum circuit being associated with variational parameters; and measuring a cost function value on the quantum register, the cost function value representing the output of the QNN.

In an aspect, this disclosure relates to a system for training a generative model associated with a probability density function, PDF, in one or more dimensions, the probability density function being parameterized by a possibly higher-dimensional variable and, optionally, one or more further parameters, such as time, preferably the probability density function being associated with one or more stochastic differential equations, SDEs, using a hybrid data processing system comprising a classical computer system and a special purpose processor, preferably a quantum processor, wherein the system is configured to perform the steps of: receiving, by the classical computer, a set of information about a distribution function associated with a probability density function, the set of information including measurements of a stochastic process and/or an explicit or implicit functional description of the distribution function; and executing, by the classical computer, a training process for training a QNN using training data based on the set of information and a loss function, the training process comprising execution of the QNN by the quantum processor, the execution of the QNN comprising: preparing a quantum register of the quantum processor in the initial state; applying a quantum circuit defining a quantum feature map for encoding the variable to the quantum register; applying the first parameterized quantum circuit to the quantum register, the first parameterized quantum circuit being associated with variational parameters; and measuring a cost function value on the quantum register, the cost function value representing the output of the QNN.

In an aspect, the invention may relate to a method for solving a stochastic differential equation, SDE, using a hybrid data processing system comprising a classical computer and a special purpose processor.

In an embodiment, the method may include receiving by the classical computer a partial differential equation, PDE, the PDE describing dynamics of a quantile function QF associated a stochastic differential equation SDE, preferably the partial differential equation defining a quantilized Fokker-Planck QFP equation, the SDE defining a stochastic process as a function of time and one or more further variables and the QF defining a modelled distribution of the stochastic process; executing by the classical computer a preliminary training process for training one or more neural networks to model an initial quantile function, the one or more neural networks being trained by the special purpose processor based on training data, the training data including measurements of the stochastic process; executing by the classical computer a training process wherein the one or more neural networks that are trained by the preliminary training process are further trained by the special purpose processor based on the QFP equation for one or more time intervals to model the time evolution of the initial quantile function; and, executing by the classical computer a sampling process based on the quantile functions for the one or more time intervals, the sampling process including generating samples of the stochastic process using the quantile function, the generated samples representing solutions of the SDE.

Thus, the invention relates to a method to generate sets of samples that form solutions to a time-evolution of a stochastic differential equation, SDE. The samples may be generated based on quantile functions (QFs) and derivatives thereof that is associated with the SDE. To that end, the SDE may be rewritten as a set of differential equations for the quantile function. Further, a neural network representation of the QF and its derivatives may be determined, which can be used to generate samples that form solutions of the SDE. The neural network representation may be a classical neural network or a quantum neural network. Feature maps and differentiable quantum circuits (DQCs) may be used to directly represent the quantile function of the probability distribution for underlying SDE, and propagate them in time by solving the differential equations of quantile mechanics.

In an embodiment, the special purpose processor may be a quantum processor configured to execute operations associated with one or more quantum neural networks QNNs. QNN allow a high-dimensional feature space, are suitable even for systems of high-correlations, may be used to create functions from many basis functions, are resistant to overfitting due to unitarity. QNN has potentially lower energy consumption than big NN depending on HW implementation, scales even better with dimensionality than PINN due to efficient parallel/serialization of feature maps, corresponding to very deep NN case. QNNs allow a quantum quantile mechanics (QQM) approach may be wherein quantum neural networks are used to model the quantile function associated with a SDE.

In an embodiment, the training process may include receiving or determining, by the classical computer system, a formulation of quantum circuits representing the PDE describing the dynamics of a quantile function, preferably the quantum circuits being parameterized by at least one latent variable z associated with the SDE through its quantile functional description, and the quantum circuits including one or more function circuits for determining one or more trial functions values f(zⱼ) around one more points zⱼ and one or more differential function circuits for determining one or more trial derivative values, preferably one or more first order trail derivative and one or more second order trail derivatives, around the one or more points zⱼ.executing, by the quantum processor, the quantum circuits for a set of points zⱼ in the variable space z of the PDE; receiving, by the classical computer system, in response to the execution of the quantum circuits quantum, hardware measurement data; and, determining, by the classical computer system, based on the quantum hardware measurement data and a loss function, if the quantum hardware measurement data forms a solution to the PDE.

In an embodiment, the training process may include solving the PDE based on differentiable quantum circuits DQCs, the differentiable quantum circuits including a first feature map quantum circuit which is a function of a differentiable variable x of the PDE, a second feature map quantum circuit which is a function of a differentiable variable t of the PDE encoding the time evolution of the quantum circuit and a quantum circuit representing a variational ansatz.

In an embodiment, the determining if the quantum hardware measurement data forms a solution to the one or more Des may be further based on one or more boundary conditions associated with the one or more Des

In an embodiment, executing the quantum circuits may include: translating each of the quantum circuits into a sequence of signals and using the sequence of signals to operate qubits of the quantum computer; and/or, wherein receiving hardware measurement data includes: applying a read-out signal to qubits of the quantum computer and in response to the read-out signal measuring quantum hardware measurement data.

In an embodiment, the one or more quantum neural networks for modelling the quantile function may include gate-based qubit devices, optical qubit devices and/or gaussian boson sampling devices.

In an embodiment, during the preliminary training process the one or more neural networks may be trained using a quantum generative adversarial network, qGAN, process, including a quantum generator neural network and a quantum discriminator neural network.

In an embodiment, random numbers may be generated by a classical computer which are fed into the one or more quantum neural networks that model the quantile functions for different time instances, for generate multiple sets of a samples wherein each set of samples has a distribution representing a solution to the SDE. In an embodiment, random numbers may be generated by the quantum computer, preferably the random numbers being generated by the quantum neural network, the quantum GAN or QCBM setting.

In an embodiment, the special purpose processor is a GPU, TPU or FPGA-based hardware processor configured to execute operations associated with one or more neural networks NNs.

In an embodiment, during the preliminary training process the one or more neural networks are trained using a generative adversarial network, GAN, process, including a generator neural network and a discriminator neural network.

In an embodiment, the training process may include solving the PDE based on one or more trained neural networks, preferably physics informed neural networks PINNs, the one or more trained neural networks being trained to model the quantile function and the derivative constraints on the quantile function as defined by the PDE for different time instances.

Thus, the invention allows determination a neural network-based NN-based sample generator representing the quantile function associated with the SDE. The NN-based sample generated may be implemented as a classical neural network, in particular a physics information neural network PINN or a quantum neural network QNN. PINNs are robust against the curse of dimensionality, scales much better than FEM for solving PDEs in many cases. Moreover, PINNs provide more flexibility than Finite Element Methods, because the loss function description can include many more flexible details including data.

In an embodiment, random numbers may be generated by a classical computer which are fed into the trained one or more neural networks that model quantile functions for different time instances, to generate multiple sets of a samples wherein each set of samples has a distribution representing a solution to the SDE.

In an embodiment, the SDE may define a reverse-time SDE, or backward SDE, or forward SDE, or reverse-time backward SDE.

In an embodiment, the second order derivatives of the PDE may be computed using the parameter-shift rule, as described by equation 15 in this application.

In a further aspect, the invention may relate to a system for solving one or more stochastic differential equations, SDEs, using a hybrid data processing system comprising a classical computer system and a special purpose processor, wherein the system is configured to perform the steps of: receiving by the classical computer a partial differential equation, PDE, the PDE describing dynamics of a quantile function QF associated a stochastic differential equation SDE, preferably the partial differential equation defining a quantilized Fokker-Planck QFP equation, the SDE defining a stochastic process as a function of time and one or more further variables and the QF defining a modelled distribution of the stochastic process; executing by the classical computer a preliminary training process for training one or more neural networks to model an initial quantile function, the one or more neural networks being trained by the special purpose processor based on training data, the training data including measurements of the stochastic process; executing by the classical computer a training process wherein the one or more neural networks that are trained by the preliminary training process are further trained by the special purpose processor based on the QFP for one or more time intervals to model the time evolution of the initial quantile function; and, executing by the classical computer a sampling process based on the quantile functions for the one or more time intervals, the sampling process including generating samples of the stochastic process using the quantile function, the generated samples representing solutions of the SDE.

In a further aspect, the invention may relate to a system for solving one or more stochastic differential equations, SDEs, using a hybrid data processing system comprising a classical computer system and a special purpose processor, wherein the system is configured to perform any of the steps as described above.

The systems and methods described in this application illustrate how to train a neural network as a QF based on data and/or a known model at an initial point of time, and find a time-propagated QF which can be used for high-quality sampling to obtain data sets that are solutions to the underlying SDE. When using quantum neural networks in the DQC form, the advantages of quantum-based learning may be exploited. Differential equations for quantile functions may be used for training differentiable quantum circuits. A quantum quantile learning protocol is described for inferring QF from data and use quantile quantum mechanics QQM to propagate the system in time. This provides a robust protocol for time series generation and sampling.

In an embodiment, the differential equation(s) include one or more (non-) linear stochastic differential equations, including but not limited to those of Ito and Stratonovich form.

An implementation of the method described on the basis of the embodiments in this application, implemented on noisy quantum hardware with finite logical gate error and finite coherence times

An implementation of the method on noisy quantum hardware wherein the subroutines of the algorithm may be executed by multiple quantum devices operating in parallel and/or in series, routing measurement data to one classical computer which computes the loss function value each iteration.

An implementation of the method described on the basis of the embodiments in this application, wherein instead of measuring a cost function for each part in the loss function as described, the embodiment relies on overlap estimations of left-hand-side and right-hand-side of the differential equations in functional form, considering the quantum hardware quantum information overlap as functional overlap.

An implementation of the method described on the basis of the embodiments in this application, based on qubit-based quantum hardware, where the quantum information carriers are embodied by qubits or quantum bits.

An implementation of the method described on the basis of the embodiments in this application, where the quantum hardware consists of a continuous-variable system, such that information carriers are defined by continuous quantum variables

The invention may also relate to a computer program or suite of computer programs comprising at least one software code portion or a computer program product storing at least one software code portion, the software code portion, when run on a computer system, which may include a classical computer and a special purpose process, e.g. a quantum computer or a GPU, TPU or FPGA based special purpose processor for exacting neural networks that are used for representing quantile function associated with an SDE and to compute the time evolution of quantile functions based on an partial differential equation describing the dynamics of the quantile function.

The invention may also relate to a method and a system for training a generative model using a hybrid data processing system comprising a classical computer and a quantum processor, the method comprising: receiving by the classical computer a set of information about a stochastic process, including samples (data) and/or parametric analytical function or parametric (implicit) distribution function, preferably the distribution function defining a probability density function (PDF) in one or more dimensions, parametrized by a variable x and, optionally, one or more further parameters, such as time; and, executing by the classical computer a training process for training a quantum neural network (QNN) to model a probability density function, the training data including measurements of the stochastic process and/or functional descriptions of the distribution, the QNN including a feature map for encoding a variable x of the distribution function, a variational circuit associated with variational parameters, and a cost function for determining the output of the QNN.

The invention may further relate to a non-transitory computer-readable storage medium storing at least one software code portion, the software code portion, when executed or processed by a computer, is configured to perform any of the method steps as described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1. schematically describes a general data-driven generative modelling setting;

FIG. 2. schematically describes a general data-driven generative modelling setting;

FIG. 3 depicts a system for generative modelling using quantum computation according to an embodiment;

FIG. 4 schematically depicts a QCBM depicts as an example of a quantum generative model;

FIG. 5 schematically depicts a QGAN as a further example of a quantum generative model;

FIG. 6. shows a schematic diagram of a DQGM workflow according to an embodiment;

FIGS. 7A and 7B schematically show DQGM training and sampling according to an embodiment;

FIG. 8 schematically shows frequency-taming techniques according to an embodiment;

FIG. 9 schematically shows feature map sparsification according to an embodiment;

FIGS. 10A and 10B show a schematic of a variational feedback loop for a DGQM-based quantum algorithmic subroutine;

FIG. 11A-C are hardware-level schematics of quantum processors for executing qubit operations;

FIG. 12 is a hardware-level schematics of the actions effectuating the logical operations shown in FIG. 7;

FIG. 13 shows a schematic depiction of a quantum circuit used to represent a quantum copula as DQGM according to an embodiment;

FIG. 14 shows numerical results comparing the DQGM and QCBM approaches to learn the normal distribution, with;

FIG. 15 shows numerical results of Fourier initialization of DQGM according to an embodiment;

FIG. 16A shows a specific form of a stochastic differential equation known as the Ornstein-Uhlenbeck process and FIG. 16B shows numerical results comparing DQGM trained only on data and including differential constraints applied to the Ornstein-Uhlenbeck process;

FIG. 17 shows numerical results of classical stochastic differential equation sampling using an Euler-Maruyama approach; and comparing to DQGM approach

### DESCRIPTION OF THE EMBODIMENTS

Quantum computing can offer a computational advantage by meticulous usage of an exponentially large Hilbert space for qubit registers. However, efficient solutions are only expected for some problem types. Thus, the use of quantum computing is currently limited to specific tasks that can exploit the specific advantages of quantum computing and that cannot be solved efficiently using classical computers. One example corresponds to sampling from quantum states created by random entangling circuits. This task lies at the heart of quantum supremacy experiments. While being computationally advantageous for producing random samples (just need to send a ‘measure’ instruction), the sampled probability distributions are typically not suitable for industrially relevant applications. Finding a subset of problems of distributions which are both classically-intractable and (commercially) useful is an open challenge. One such subset of problems is generative modelling.

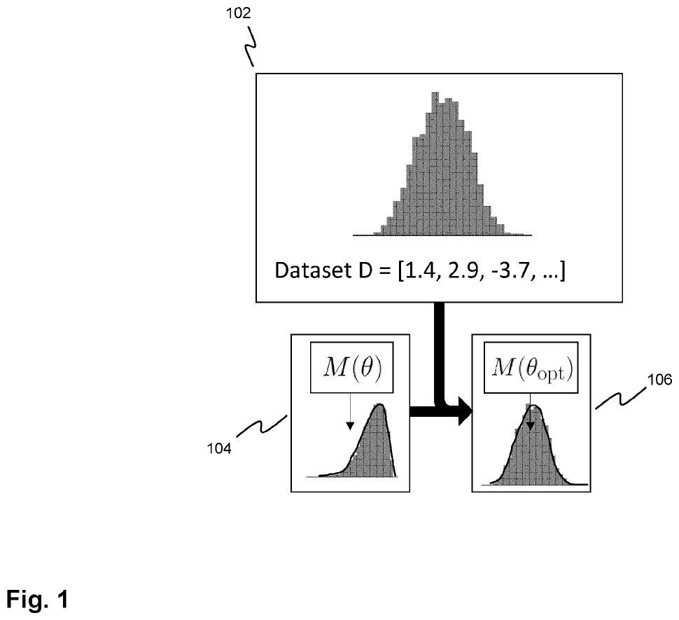

FIG. 1 schematically describes a general (classical) data-driven generative modelling setting. Given a dataset D 102 of discrete or continuous-variable numbers or vectors, parameters θ of a model M(θ) 104 are variationally optimized to obtain an optimised model M(θₒₚₜ) with parameters θₒₚₜ 106. When the optimised model is a good representation of the dataset D, data sampled from the optimised model resemble the original distribution D underlying the input training data. The probability density function of this optimised model has approximately the same shape as the (normalized) histogram of the input dataset. For example, a Gaussian distribution will have a normal-distribution probability density function, and a histogram from its samples will have a normal-distribution shape.

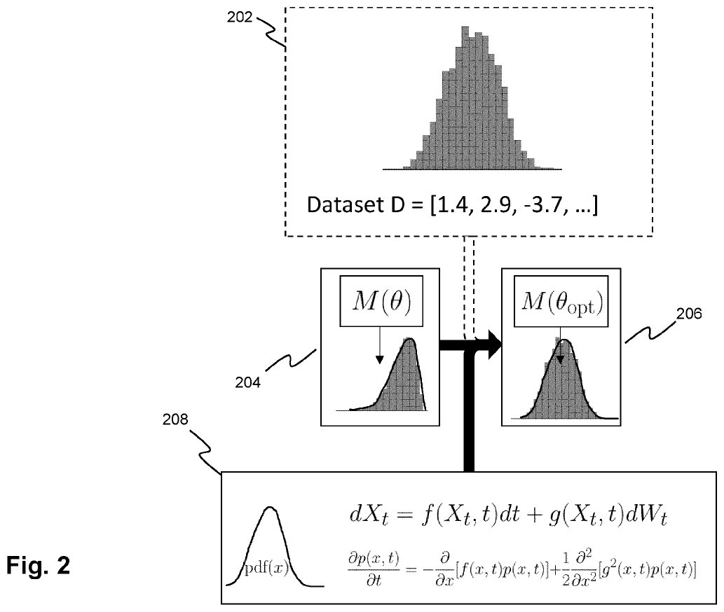

FIG. 2 schematically describes an another general data-driven generative modelling setting. If the input dataset D 202 results from a system of stochastic differential equations 208 (discussed in more detail below with reference to eq. (6)), the optimised model 206 may be constrained by temporal and/or spatial derivatives of the stochastic differential equations 208. Typically, an equation of motion may be determined for the time-dependent probability distribution function of a stochastic variable, e.g., a Fokker-Planck equation (FPE) or a Kolmogorov backward equation (KBE). This way a time evolution of the distribution can be determined. Models that are constrained by such derivatives typically give a more faithful representation of the underlying processes, and hence result in better data. However, optimising both a model and its derivatives is not a trivial task, and is in many cases not even possible.

In contrast to classical generative modelling, quantum generative modelling (QGM) aims to exploit a quantum model comprising a plurality of trainable quantum circuits that can prepare distributions as quantum states, for instance trying to match patterns from available data. Being a subject of emerging quantum machine learning (QML), quantum generative modelling utilizes the Born rule which gives the probability that a measurement of a quantum system will yield a given result. The goal is to represent a parametrized probability distribution p_{θ}(x) as a probability to measure a bit string x from a variational state |ψ_{θ} [symbol] parametrized by a vector of gate parameters θ. For the simple case of pure states this reads p_{θ}(x)=| [symbol] x|ψ_{θ} [symbol] ².

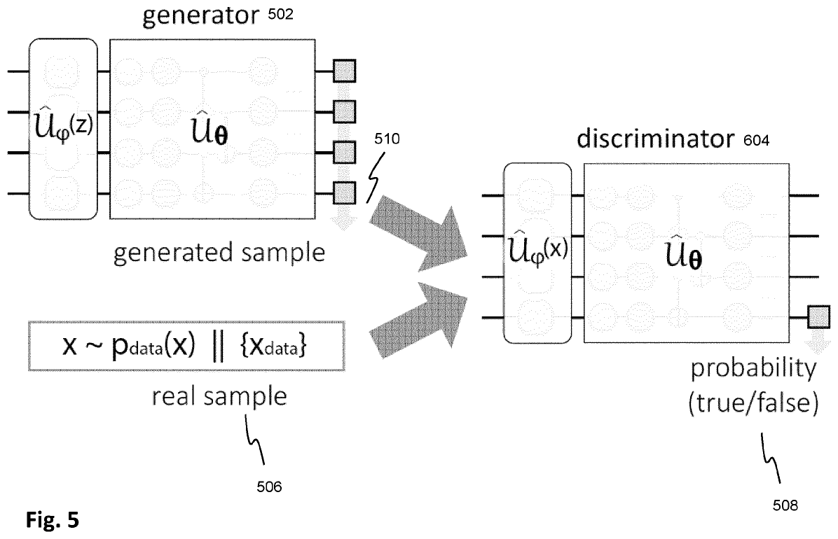

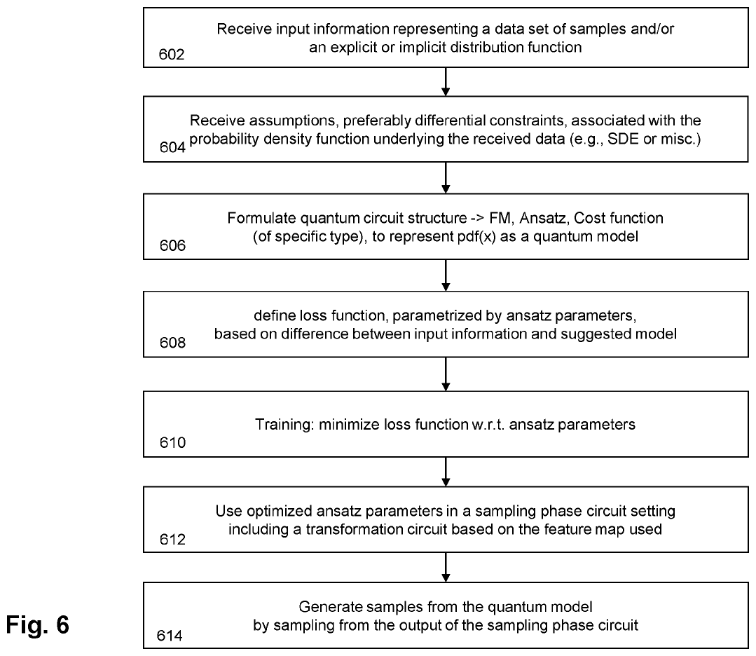

Known QGM methods include an approach based on quantum circuit Born machines (QCBMs) that learn models directly from samples of a target distribution p_{target}(x) using various loss functions. Here, directly means that a sample can be determined directly from a measured wavefunction, so that for one sample in principle only one quantum measurement is needed. QCBMs are discussed in more detail below with reference to FIG. 5. A similar approach may be used for generating circuits in quantum generative adversarial networks (QGANs), where a training schedule usually corresponds to the minimax game. QGANs are discussed in more detail below with reference to FIG. 6. Quantum circuit Born machines have previously been used for loading static distributions corresponding to bars—and—stripes datasets, learning datasets of correlated currency pairs, and digitized Gaussian and bimodal distributions. Quantum generative adversarial networks were used for (reduced) MNIST datasets, financial modelling, learning pure states, and sampling particle traces.

While making a step towards sampling-based advantage, which means a quantum advantage over classical sampling methods, current QGM performance is largely limited even for idealized state vector simulators. First, the generators described in the prior art are very difficult to train, as they require matching O(2^{N}) amplitudes for N-qubit registers and require finding a corresponding state for some vector θ. Second, QCBM and QGAN architectures are not automatically differentiable with respect to variable x, and have limited application for solving stochastic differential equations (SDEs). The latter would be hugely beneficial as differential constraints remove strong dependence on data, the need to regularize models, and offer additional structure to learning. SDE-based sampling is also motivated by works in which Monte-Carlo techniques are used, e.g. in the financial sector.

The difficulty of training quantum generators may be partially alleviated using feature map encoding of continuous distributions, at the expense of requiring multi-shot measurements to get a sample from QNNs, meaning potentially many quantum measurements need to be taken to get a single sample out. The second point may be remedied (at east in part) by quantum quantile mechanics (QQM)—as described in co-pending application EP4131075A1, which is hereby incorporated by reference—where a quantum circuit is trained to generate samples from SDEs and can be evolved in time, albeit with the same issue of many required quantum measurements through expectation-based sampling. Combining differentiability with fast sampling will offer both an expressivity advantage and a sampling advantage of quantum computing.

In this disclosure, embodiments are described for scalable training of quantum generators that can be differentiated with respect to a continuous stochastic variable. The method comprises separate training and sampling stages of quantum generative modelling. During the training stage, a model is built in a latent space (taken as a phase) enabled by a phase feature map, which is followed by a variational circuit and DQC-type readout, meaning expectation values are read out in the training part. The sampling stage is then performed in a bit basis space enabled by a fixed unitary transformation (e.g., a quantum Fourier transform), and may be followed by projective measurements for a sample-by-sample readout.

The described embodiments define differentiable quantum generative modelling (DQGM) circuits, which may be used for sampling from stochastic differential equations. Another advantage of training the quantum model in the phase space is that the model is inherently regularized. This is enforced by qubit-wise learning, feature map sparsification, and frequency-taming techniques for circuit initialization based on Fourier series.

A probability distribution (or alternatively, a generic function) may be loaded into state amplitudes, after which the Fokker-Planck equations may be solved, giving access to a time-series of the Black-Scholes model. Finally, considering correlated registers where quantum correlations are included by entangling circuits, examples are given of classically hard multi-dimensional distributions that can be automatically “inverted” by quantum computers. This leads to a sampling advantage. These aspects will be described hereunder in more detail.

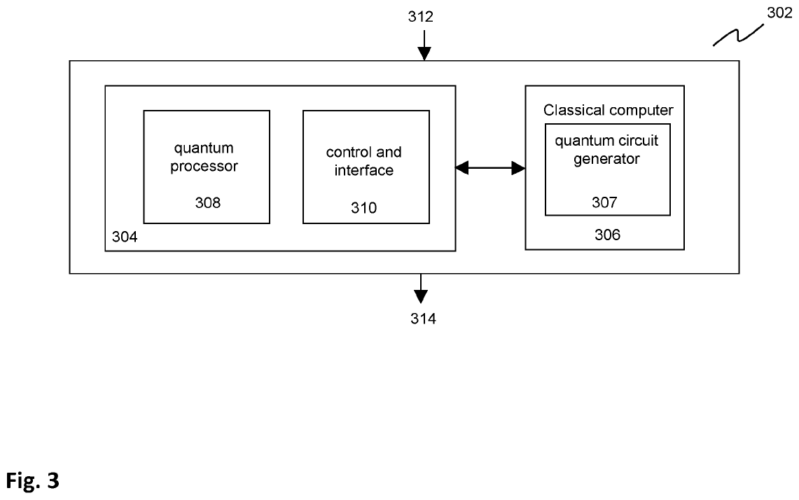

FIG. 3 depicts a hybrid computer processor 302 comprising a quantum computer system 304, one or more quantum processors 308, e.g. a gate-based quantum processor, and a controller system 310 comprising input output (I/O) devices which form an interface between the quantum processors and the outside world, e.g. the one or more classical processors of a classical computer 306. For example, the controller system may include an optical or electrical system for generating optical or electrical pulses respectively which are used to manipulate the qubits. Further, the controller may include readout circuitry for readout of the qubits. For at least a part such readout circuitry may be located or integrated with the chip that includes the qubits.

The system may further comprise a (purely classical information) input 312 and an (purely classical information) output 314. Input data may include information about the training data, stochastic differential equation(s) used as constraints in the generative modelling. This information may include the dimensionality, order, degree, coefficients, boundary conditions, initial values, regularization values, etc. The input data may be used by the system to classically calculate values, e.g. parameter settings, which may be used to initialize the quantum circuit that is implemented on the quantum processor. Similarly, output data may include loss function values, sampling results, correlator operator expectation values, optimization convergence results, optimized quantum circuit parameters and hyperparameters, and other classical data.

Each of the one or more quantum processors may comprise a set of controllable multi-level quantum systems, e.g. two-level quantum systems referred to as qubits. The two levels are |0 [symbol] and |1 [symbol] and the wave function of a N-qubit quantum processor may be regarded as a complex-valued superposition of 2^{N} of these distinct basis states. Examples of such quantum processors include noisy intermediate-scale quantum (NISQ) computing devices and fault tolerant quantum computing (FTQC) devices. Alternatively and/or in addition, the one or more quantum processors may comprise a set of continuous variable systems, such as optical or photonic quantum computers. Furthermore, the quantum processor may comprise a Gaussian Boson Sampling device.

Generative modelling concerns the process of drawing samples of a stochastic variable X˜P_{θ}(x) for a trainable parametrized distribution. In the generic quantum case, the quantum model may be constructed using Born's rule, p_{θ}(x)=tr{|x [symbol] [symbol] \hat{p}θ}, where samples x corresponding to length-N binary strings are readout from the density operator \hat{p}_{θ}=ε_{θ}(\hat{p}₀) created by a parametrized completely positive trace-preserving (CPTP) map ε_{θ} from some initial density operator \hat{p}_{θ}. The latter typically corresponds to the computational zero state \hat{p}₀=|ø [symbol] [symbol] |, where |ø)=|0)^{⊗M} for M≥N. In many cases unitary quantum channels are considered, ε_{θ}(\hat{p}₀)= [symbol] _{θ}\hat{p}₀ U_{θ}^{†} with M=N and U_{θ} is a generic parametrized unitary operator operating on the N-qubit register. When U_{θ} ∈ [symbol] [symbol] (2^{N}), in principle, any state of the register can be prepared, and such model may be called maximally expressive. Typically, QCBM-style generative modelling relies on sample-based training of p_{θ}^{QCBM}(x)=tr{x}|x) [symbol] x|Û_{θ}\hat{p}₀Û_{θ}†} at digital (i.e. integer, binary) values of x only. The generic goal is to minimize a loss function [symbol] _{θ}^{QCMB}=Σₓ₌₀^{2N-1} [symbol] [p_{target}(x), p_{θ}^{QCBM}(x)], for some distance measure [symbol] [·,·], and getting optimal angles θₒₚₜ=argmin_{θ}[ [symbol] _{θ}^{QCBM}]. Once p_{θ}^{QCBM}(x) is successfully trained, the optimized circuit can be directly used for generating samples.

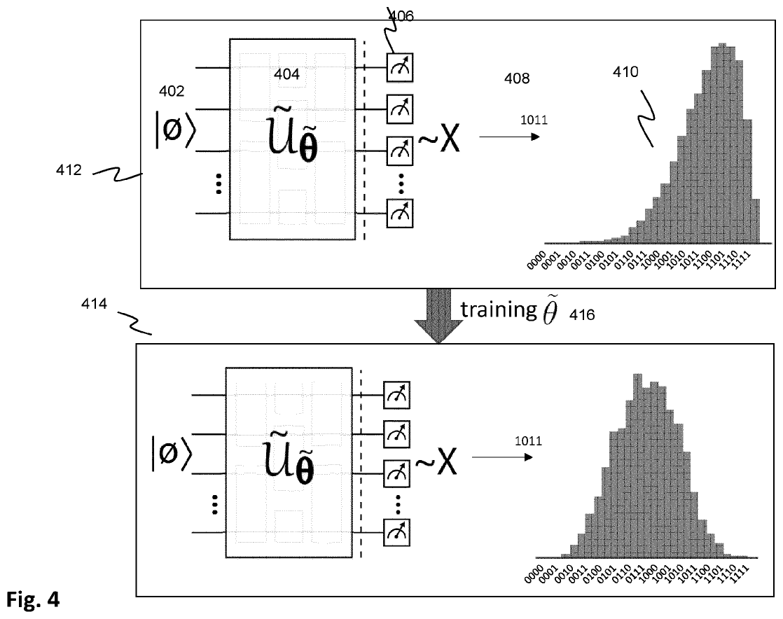

FIG. 4 schematically depicts a QCBM as an example of a quantum generative model. A QCBM can be executed on a qubit-based quantum processing architecture in hybrid feedback loop with a classical computer as explained above with reference to FIG. 3. Initially in a learning phase 412, qubits of a quantum processor may first be initialized in the |0) state 402. Then, a unitary operation 404 (such as a gate-based quantum circuit, or a Hamiltonian evolution, etc.) may be performed on the qubits, which is parameterized by some classical numbers θ controlled by the classical computer. Finally, samples are extracted simply by measuring the qubits in the Z-basis (bit-basis) 406 to result in bitstrings X such as {1011} (408). After sampling many times, a distribution or histogram 410 can be constructed from the ensemble of results. This histogram can be compared to an existing target distribution using various comparisons, including Kullbeck-Leibner divergence, etc. The difference is minimized in an optimization loop called ‘training’ 416 with respect to parameter θ. After training 414, the output, when sampled, resembles the target distribution within a small quantity of a distance measure such as Kullback-Leibler divergence

FIG. 5 schematically depicts a QGAN as a further example of a quantum generative model. Quantum generative adversarial networks (QGANs) follow the same scheme as their classical counterparts, but substitute the neural representation of the generator G_{NN} and/or discriminator D_{NN} by quantum neural networks. In the following, these are denoted as G_{Q} and D_{Q}, respectively. The schedule of QGAN training and quantum circuits used for such training are presented in FIG. 5. In particular, the figures depict a typical generative adversarial network (GAN) setup including generator 502 and discriminator 504 for learning to represent a distribution from input data 506. In particular, the figures illustrate a QGAN workflow wherein quantum circuits are used both for generative modelling at t=Tₘᵢₙ (generator 502) and discrimination between real and fake samples (discriminator 504). The generator circuit G_{Q}(z) may comprise a product feature map 503 and a hardware efficient ansatz (HEA) variational circuit 505. The discriminator D_{Q}(x) is trained to distinguish, e.g. in the form of a probability measure 508, between samples generated by the generator 502 and samples 506 selected from the initial data distribution. Importantly, the generated sample is estimated using a Hamiltonian averaging procedure 510, meaning that each sample requires many measurement samples, i.e. many repetitions on the quantum processor, to be estimated accurately. This is contrary to the QCBM setting, where one (single) measurement sample (one repetition on the quantum processor) corresponds to one (single) generative sample.

The embodiments in this disclosure, which may be referred to as differentiable quantum generative modelling (DQGM), work differently compared to the known quantum generative models of FIGS. 4 and 5.

FIG. 6 shows a schematic diagram of a DQGM workflow according to an embodiment. A first step 602 may include receiving input information associated with a probability density function. The input information can include data samples (e.g., measurements of the stochastic process), explicit or implicit distribution functions or stochastic differential equations or other distribution descriptions.

An (optional) step 604 includes receiving one or more assumptions related to the probability density function. The assumptions may include, e.g., a stochastic differential equation (preferably one for which it is assumed to model the distributions well), or partial or ordinary differential equations describing (stationary) behaviour of distributions. In an embodiment, the assumptions may include constraints formulated in the form of operators on the probability density function.

Next (step 606) a training stage quantum circuit structure may be formulated. The training stage quantum circuit may include a feature map, such as a phase feature map, for transforming a point x in the real space to the (Hilbert) phase space, a quantum circuit ansatz transforming a state using one or more trainable (ansatz) parameters θ, and a cost function and/or cost operator. When the trainable quantum circuit is evaluated on a quantum processor, a measurement on an expectation value of the cost operator will represent the probability density function evaluated at a point x given to the quantum feature map.

A step 608 comprises defining a loss function. The loss function may be parameterized by the quantum circuit ansatz parameters, and may be based on the difference between input information and signatures of a suggested model, in the form of the suggested model's probability density function and/or sampling distributions. In this context, a suggested model may be considered similar to a ‘trial function’, e.g., the output of the training circuit, p(x).

A step 610 comprises training the trainable quantum circuit in order to minimize the loss function defined in step 608. The steps of training the quantum circuit include: executing the trainable quantum circuit on the quantum processor, wherein the executing includes:
1. transforming quantum gate operations of the quantum circuit into a sequence of control signals representing the quantum gate operations;
2. applying the sequence of control signals to the one or more qubits of the quantum processor to control the one or more qubits of the quantum processor to perform the quantum gate operations;
3. applying a sequence of control signals to the one or more qubits of the quantum to measure a state of the one or more qubits, the state representing an expectation value of the cost operator; and
4. minimizing the loss function on the basis of the measured expectation value; this step may comprise variationally tuning the circuit ansatz parameters until convergence criteria are met. This may result in optimized ansatz parameters θₚₚₜ.

A step 612 comprises defining a sampling phase quantum circuit structure, which is used in order to generate samples from a target distribution. The sampling phase quantum circuit may be based on the resulting optimized ansatz parameters; in that case, the generated samples correspond the optimized distribution function associated with the above described training circuit. The sampling phase circuit may include the original ansatz, daggered (meaning the unitary operation is applied in inverse, as an example for single-qubit gate rotations: the gate order is reversed and their parameters flip their sign), followed by an appropriate unitary transformation associated with the type of feature map used in the training phase.

The steps of defining the quantum circuit, and generating samples from the quantum computer given this circuit 614, include:
1. transforming quantum gate operations of the quantum circuit into a sequence of control signals representing the quantum gate operations;
2. applying the sequence of control signals to the one or more qubits of the quantum processor to control the one or more qubits of the quantum processor to perform the quantum gate operations;
3. applying a sequence of control signals to the one or more qubits of the quantum to measure a state of the one or more qubits, a single measurement representing a single sample generated at the output in the computational bit-basis; and
4. repeating the sampling process to generate the desired number of samples.

In an embodiment, the training process of step 612 may comprise execution of the QNN by the quantum processor. The execution of the QNN may comprise:
preparing a quantum register of the quantum processor in an initial state;
applying a quantum circuit defining a quantum feature map to the quantum register, the quantum feature map encoding the variable x;
applying a variational quantum circuit associated with variational parameters to the quantum register; and
measuring a cost function value on the quantum register, the cost function value representing the output of the QNN.

In an embodiment, the sampling process of step 614 may comprise generating samples of the modelled stochastic process by the quantum processor. The generation of samples may comprise:
preparing the quantum register of the quantum processor in the initial state;
applying a second parameterized quantum circuit to the quantum register, the second parameterized quantum circuit comprising an inverse of the first parametrized quantum circuit of the trained QNN;
applying a unitary transformation, preferably a quantum Fourier transform circuit, associated with the feature map used in the training process, and
measuring the quantum register in a computational basis associated with the feature map, yielding bitstrings as measurement results, each bitstring representing a sample from the modelled stochastic process.

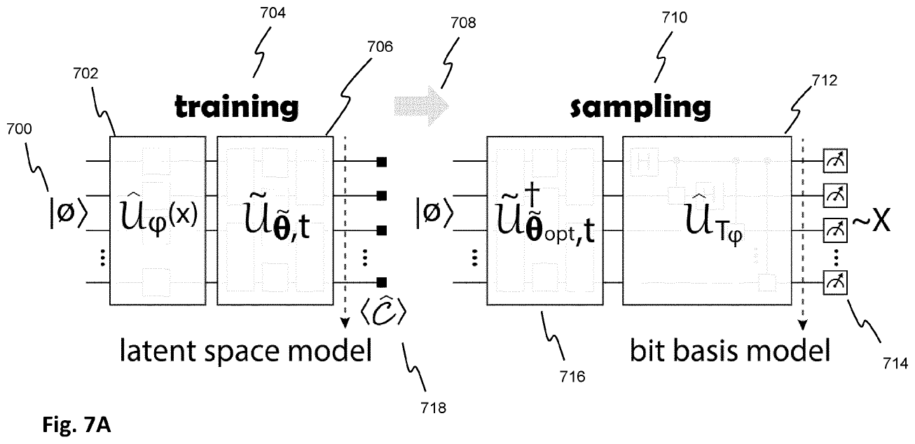

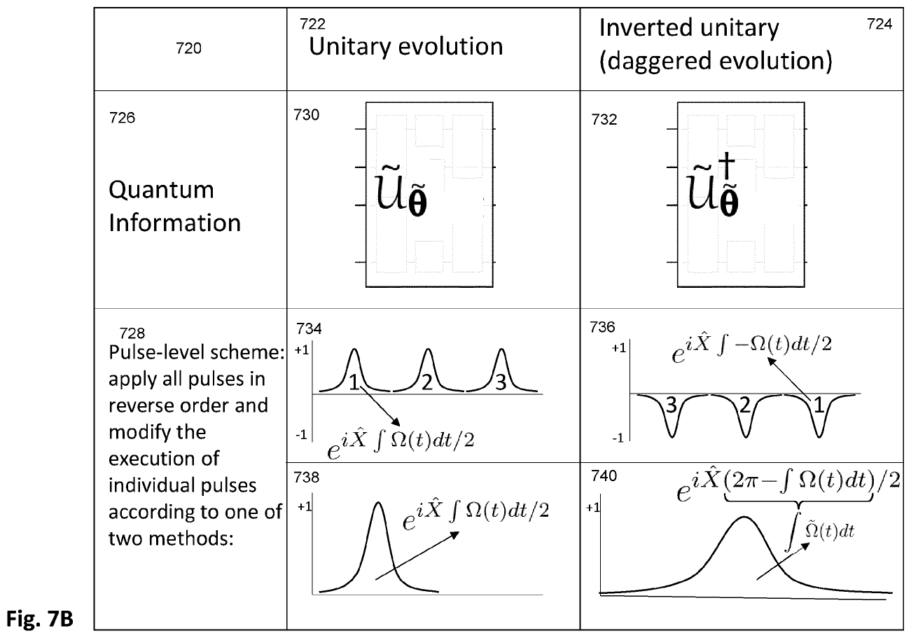

FIG. 7A schematically shows DQGM training and sampling process according to an embodiment. The method comprises a training stage 704 for training quantum neural network and a sampling stage 710, wherein a quantum circuit is used for generating samples. In the training stage, a latent space quantum model representation is used, where a phase feature map 702 is directly followed by variational circuit 706 and a cost function 718 for measuring the output of the latent (phase) space model. This latent space quantum model representation may be referred to as a quantum neural network (QNN). Thus, the QNN defines a variational quantum circuit that is trained to represent a function or value, in this particular case a probability density function.

The training of the QNN includes initialization of the qubits 700 in an initial state, the application of a quantum feature map unitary 702 to map a real parameter x into the Hilbert phase space (which may be regarded as the “input x to the QNN”), the application of a variational quantum circuit 706 (an ansatz) parameterized by ‘variational parameters’ θ, as well as fixed additional parameters t governing the shape of probability distribution that is modelled and a measurement of a cost function value [symbol] [symbol] [symbol] (C) on the qubits of the quantum computer, wherein the cost function value represents the probability density function value evaluated at x, p_{θ,t}(x)= [symbol] [symbol] [symbol] 718. In this application, the QNN cost function is assumed to be a p₀ state or a local cost operator, and can be measured by Hamiltonian averaging, QPE, state-overlap or other operator estimation techniques.

At the sampling stage 710, the trained variational circuit 716 is daggered and the model from the latent space is mapped to a bit space using a transformation unitary 712, while the feature map and inverse basis transformation are treated as projective measurement and are subsumed in a sampling process 714.

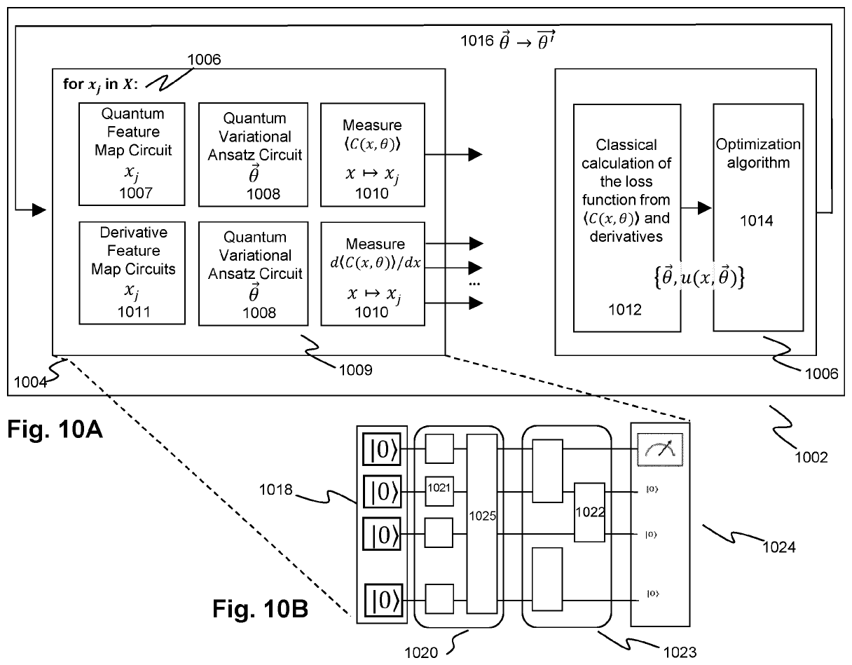

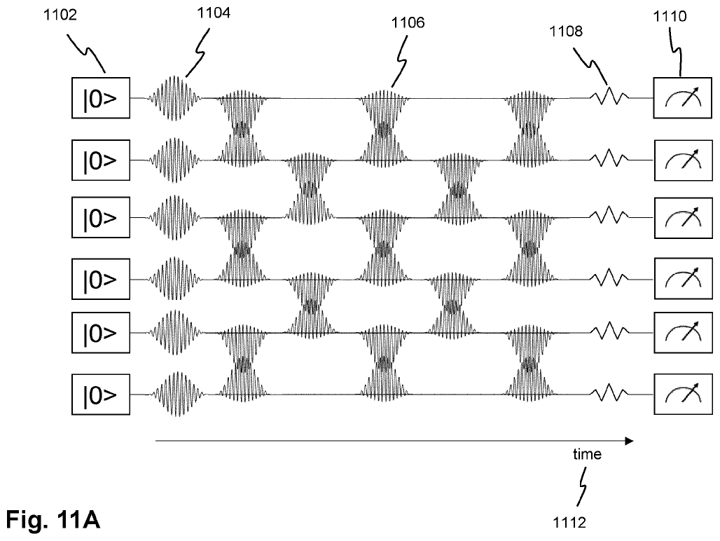

These steps will be described in more detail below, wherein coefficients such as variational coefficients θ may be optimized in a quantum-classical hybrid loop in order to reduce the loss function value for θ settings as described below with reference to FIG. 10.

A protocol for generating computational states {|x [symbol] } (each associated to binary strings x ∈ [symbol] ={00 . . . 0, 10 . . . 0, . . . , 11 . . . 1}) may be executed in two steps, as follows. First, a parametrized feature map [symbol] _{φ}(x) 702 may be created which represents a latent (phase) space representation of the variable x, \hat{p}ₓ= [symbol] _{φ}(x)\hat{p}₀ [symbol] _{φ}^{†}(x). Here, \hat{p}ₓ may be a density operator encoding variable x in the phase space. The corresponding circuit may be referred to as the phase feature map. For \hat{p}₀=|ø [symbol] [symbol] ø|, the phase feature map may for example be expressed as a sequence of single qubits operations

$${\hat{𝒰}}_{φ} ( x ) = {\prod }_{j = 1}^{N} [ {\hat{R}}_{j}^{z} ( \frac{2 π x}{{2}^{j}} ) {\hat{H}}_{j} ] \qquad ( 1 )$$

where Rⱼ^{z}(ϕ)=cos(ϕ/2) [symbol] −i sin (ø/2)\hat{Z}ⱼ is a single-qubit rotation and Ĥⱼ is a Hadamard gate, acting at qubit j. In an embodiment, (restricted) qubit-dependent coefficients ξⱼ may be included that may be used for transforming (stretching or squeezing) coordinate x. The phase feature map of Eq. (1) maps an initial state into a superposition product state \hat{p}ₓ=|\tilde{x} [symbol] [symbol] \tilde{x}| based on the latent state |\tilde{x}:= [symbol] _{φ}(x) |ø), which explicitly reads

$${{\vert \vec{x} 〉 = \frac{{e}^{- i Φ / 2}}{{2}^{N / 2}} {⊗}_{j = 1}^{N} ( \vert 0 〉}_{j} + exp ( - i \frac{2 π x}{{ξ}_{j} {2}^{j}} ) \vert 1 〉}_{j} ) , \qquad ( 2 )$$

where Φ=2π(1−2^{-N}) is an overall phase. Importantly, the phase space representation contains all computational basis states, which can be labelled by integers { [symbol] }={0,1, . . . , 2^{N}−1}. States associated with these computational basis states are not entangled.

Next, a quantum circuit Û_{T} may be applied 712 such that it transforms latent states {| [symbol] )} into binary states {|x)} as a bijection. The corresponding density operator \hat{p}ₓ=Û_{T}\hat{p}ₓÛ_{T}^{†} thus encodes the variable x in the bit basis. The simplest case for such a transformation is for ξ=1 ∀j. In this case, the mapping corresponds to an inverse quantum Fourier transform (QFT) circuit, Û_{T}=Û_{QFT}^{†}, which comprises O(N²) gates (Hadamard gates and controlled-phase gates).

Having generated the state \hat{p}ₓ, a variational ansatz may be applied. This variational ansatz may be chosen in the form [symbol] _{θ}= [symbol] _{θ}U_{T}^{†}, where the tilde in \tilde{θ} and [symbol] _{θ} indicates that the circuit structure and parametrization angles as described in this disclosure are those of the DQGM methods, which are different from the circuit structure and parametrization angles according to known QCBM methods.

The DQGM model is built and trained 704 fully in the latent space, \tilde{p}_{θ}(x)=tr{ [symbol] _{ø} [symbol] _{\tilde{θ}}\tilde{ρ}_{\tilde{x}} [symbol] _{\tilde{θ}}^{†}}, with a cost (measurement) operator 718 being [symbol] _{ø}=p₀. The model is trained to match the target distribution for

$${\tilde{θ}}_{opt} = arg {min}_{\tilde{θ}} {\sum }_{x ∈ 𝒳} 𝒟 [ {p}_{target} ( x ) , {\tilde{p}}_{\tilde{θ}} ( x ) ] \qquad ( 3 )$$

for a grid [symbol] of real-valued x ∈ [0, 1). Due to training in the latent space, the cost can be, e.g., a local operator, or a single-ancilla SWAP test for measuring the overlap. Because X˜p_{θ}_{ₒₚₜ}=tr{|x [symbol] [symbol] x [symbol] _{T} [symbol] _{θopt} ^{†}\hat{p}₀ [symbol] _{θopt}U_{T}^{†}}, the trained model may be sampled 714 using projective measurements.

To show that the model can successfully be sampled in the bit basis, the connection between DQGM and QCBM may be formulated as follows: probability distributions of binary samples {X} from maximally expressive QCBM at global optimum θₒₚₜ and maximally expressive DQGM at global optimum \tilde{θ}ₒₚₜ are equivalent. This follows form the following observations. Generative modelling from QCBM can be expressed as sampling from an generalized probability distribution

$${p}_{θ}^{g Q C B M} ( x ) = tr \{ \vert x 〉 〈 x \vert {\hat{𝒰}}_{θ} {\hat{ρ}}_{0} {\hat{𝒰}}_{θ}^{†} \} = t r \{ {\hat{𝒞}}_{θ} {\hat{𝒰}}_{φ}^{†} ( x ) {\hat{𝒰}}_{T}^{†} {\hat{𝒰}}_{θ} {\hat{ρ}}_{0} {\hat{𝒰}}_{θ}^{†} {\hat{𝒰}}_{T} {\hat{𝒰}}_{θ} \} , \qquad ( 4 )$$

where U_{φ}^{†}(x) corresponds to the phase feature map. At digital values of the variable x, Eq. (4) corresponds to p_{θ}^{QCBM}(x), but extends QCBM to x ∈ [symbol] . Note that in the intervals between digital points [symbol] <x< [symbol] +1( [symbol] =0,1, . . . 2^{N}−2) the samples come from the superposition of neighbouring states, ∝α| [symbol] [symbol] +β| [symbol] [symbol] (with x-dependent complex coefficients α, β), preserving sampling locality. The latent DQGM model can be rewritten as

$${\tilde{p}}_{\tilde{θ}} ( x ) = t r \{ {\hat{ρ}}_{\tilde{x}} {\tilde{U}}_{\tilde{θ}}^{†} {\hat{ρ}}_{0} {\tilde{U}}_{\tilde{θ}} \} = tr \{ \vert x 〉 ( x \vert {\hat{W}}_{\tilde{θ}}^{†} {\hat{ρ}}_{0} {\hat{W}}_{\tilde{θ}} \} \qquad ( 5 )$$

directly following from cyclic properties of the trace and previously introduced definitions.

Comparing models in Eq. (4) and Eq. (5), and given that quantum states Û_{θ}\hat{p}₀Û_{θ}^{†}and [symbol] _{\tilde{θ}}^{†}\hat{ρ}₀ [symbol] _{θ} are trained to match the same target distribution, for maximally expressive circuits Û_{θ}, [symbol] _{θ}∈ [symbol] [symbol] (2^{N}) the probability distributions match at global optimum, p_{θ}^{gQCBM}(x)=\tilde{p}_{θ}(x). This follows from the fact that both circuits are in principle capable of expressing any state (quasi-distribution), wherein [symbol] _{θ} can absorb a fixed transformation with re-adjusting the angles, and both aim to prepare the same optimal state.

While it has been shown that the two approaches are equivalent during the sampling stage, the two models are vastly different during the training stage. For the QCBM and its generalization in Eq. (4) the sampling and training settings are the same, and require a variational state to match bitstring probabilities for O(2^{N}) states already in training. This is a challenging setting and requires for deep variational circuits which is challenging for hardware due to noise in near-term devices (NISQ).

For the DQGM, only training of the latent model is required, where a superposition product state is obtained from x-parametrized single qubit rotations (spans all O(2^{N}) amplitudes) and needs a certain overlap with a variational state (also with support on O(2^{N}) amplitudes). Compared to the QCBM case, this is task is substantially easier to achieve, as will be shown below in more detail. As DQGM and QCBM originate from the same phase feature map, they have the same model capacity—a spectrum characterized by exponentially large number of frequencies (as discussed in more detail below). At the same time, DQGM has better model expressivity in terms of access to Fourier coefficients for relevant low-frequency components, thanks to the (non-variational) unitary transformation [symbol] _{T} that removes part of the training complexity.

Additionally, an important advantage of the embodiments in this disclosure is the possibility to differentiate the model. This can be done by using quantum automatic differentiation applied to the phase feature map. As the latent model is used for training, differential constraints may be applied at the training stage. Once the model has been trained, it may be sampled. Differential constraints are of importance for a wide variety of applications in, e.g., physics, finance, biology, and chemistry.

In general, a system of stochastic differential equations may be written as

$$d {X}_{t} = f ( {X}_{t} , t ) dt + g ( {X}_{t} , t ) {dW}_{t} , \qquad ( 6 )$$

where dWₜ is a standard Wiener process, Xₜ is time-dependent stochastic variable, and f(·) and g(·) are scalar functions that are typically referred to as drift and diffusion. For any stochastic differential equation in the form of Eq. (6), an equation of motion for the probability distribution may be determined for the time-dependent probability distribution function p(x,t) of the stochastic variable Xₜ, e.g., a Fokker-Planck equation (FPE) or a Kolmogorov backward equation (KBE).

Once the probability distribution function p(x,t) is known in the domain of interest t ∈ [symbol] , stochastic trajectories (samples from time-incremented distributions) may be obtained, offering full generative modelling of a time-series. However, known methods require a costly inversion procedure (or equivalent) to generate samples based on (only) the probability distribution function p(x,t), and such sample generation is challenging for multidimensional problems. Advantageously, the quantum generative models described in this disclosure only require learning t-parametrized DQGM at different times, thus giving direct access to fast sampling. The method will be discussed in more detail below.

The system of stochastic differential equations from Eq. (6) can be approached from a data-driven perspective, which starts with learning a representation of a steady state from available samples. Advantageously, this procedure enables model discovery, as drift and diffusion coefficients may not be immediately known. Setting the loss function for DQGM as

$${ℒ}_{θ}^{data} = {\sum }_{x ∈ 𝒳} 𝒟 [ {p}_{target} ( x , {t}_{0} ) , {\tilde{p}}_{θ} ( x , {t}_{0} ) ] , \qquad ( 7 )$$

a probability distribution may be determined at a point of time t₀.

Now, let us comment on two possible ways of encoding the time variable. First, time t can be embedded explicitly. One option is to use a t-dependent feature map for parameterizing the model. For instance, we employed it successfully in DQC-based quantum function propagation †cite {QQM}. In this case, it is convenient to use an identity-valued feature map at t₀, and learn to adjust angles as t deviates from t₀. Second, explicit encoding of time can take a polynomial of t (or even a feed-forward neural network), with thetas being trainable coefficients. In this case, t=t₀ training can be performed for zeroth degree term, and adjusting remaining coefficients at other times. Finally, we can also assume an implicit dependence of variational coefficients theta on time. In this case, we learn to represent data at to with parameters theta (t₀), and then demand that each point of time the distribution satisfies differential constraints for a PDE in question. This will lead to model-depend updates of variational parameters, thus evolving the model in discrete time. Below, we show how to introduce model-dependent differential constraints, and training or evolving DQGM in both explicit and implicit manner. We note both are physics-informed, and represent a step forward from static sample generation.

Once the probability distribution has been determined at to, model-dependent differential constraints may be introduced to train the DQGM in a model-informed way, which means the solutions match models such as differential equations found in physics, finance, biology etc, and to evolve the distribution in time.

Given the SDE, the associated p(x,t) requires solving a PDE either forward or backward in time. The former case corresponds to solving the Fokker-Planck equation (corresponding to Kolmogorov forward equation). A generic Fokker-Planck equation can be written as

$$\frac{\partial }{\partial t} p ( x , t ) = - \frac{\partial }{\partial x} [ f ( x , t ) p ( x , t ) ] + \frac{1}{2} \frac{{\partial }^{2}}{\partial {x}^{2}} [ {g}^{2} ( x , t ) p ( x , t ) ] , \qquad ( 8 )$$

and the system may be evolved towards a stationary state at tₛ>t from some initial distribution. The stationary distribution of the Fokker-Planck equation FPE then satisfies the second-order differential equation

$$FPE ( p , x , {t}_{s} ; f , g ) := - \frac{d}{d x} [ f ( x , {t}_{s} ) p ( x , {t}_{s} ) ] + \frac{1}{2} \frac{{d}^{2}}{d {x}^{2}} [ {g}^{2} ( x , {t}_{s} ) p ( x , {t}_{s} ) ] = 0 \qquad ( 9 )$$

The corresponding differential constraint on the probability distribution may be referred to as the FPE differential operator. Specifically, p(x, tₛ) may be substituted by \hat{P}_{θ}(x,tₛ) and a quantum generative model may be trained to respect the FPE constraint by assigning the differential loss

$${ℒ}_{θ}^{diff} = {\sum }_{x ∈ 𝒳} 𝒟 [ 0 , FPE ( {\tilde{p}}_{θ} , x , {t}_{s} ; f , q ) ] , \qquad ( 10 )$$

such that it remains true for all x. This inherently regularizes the model, and, in particular, leads to improved derivatives. This, in turn, leads to improvements for studying tails of probability distributions and for studying dynamics of probability distributions. Next, we note that we can train a quantum model to represent the PDF at some point of time to using data as a snapshot during evolution. Then, the full PDE and associated differential constraints are used to propagate it in t₀<t<tₛ interval reaching the steady state at tₛ. Specifically, we can write the differential loss based on the difference of the RHS and the LHS of the FPE, which we call as the FPE differential operator FPE (p,x,t; f,g). In minimizing the loss we assume the explicit time embedding. Then the workflow for evolving differentiable quantum generative models has the style similar to PINN/DQC workflow cite {DQC}. Once done, the model can be sampled within the trained region, and generalized in between the points.

Alternatively, we can use an evolutionary approach to updating circuit parameters. In this case, the time-derivative of our model can be re-expressed using a chain rule. The differential constraints in space and time then can be performed using a simple Euler's forward update where hyperparameters are recalculated as we “march” over the grid of times. Going beyond linear updates, more sophisticated schemes (e.g. Runge-Kutta) can be employed.

Finally, the probability distribution can also be evolved using the Kolmogorov backward equation (KBE)—instead of (or in addition to) using the Fokker-Planck equation-when a goal is to study the dynamics at times prior to the steady state. Define τ<tₛ as a backward time, the generic Kolmogorov backward equation (KBE) associated to the stochastic differential equation given in Eq. (6) reads

$$- \frac{\partial }{\partial τ} p ( x , τ ) = f ( x , τ ) \frac{\partial }{\partial x} p ( x , τ ) + \frac{{g}^{2} ( x , τ )}{2} \frac{{\partial }^{2}}{\partial {x}^{2}} p ( x , τ ) . \qquad ( 11 )$$

Using this equation, a starting point be conveniently be chosen as τ=tₛ and the probability distribution p(x, t<tₛ) may be evolved backward in time, discovering (and sampling) the model at earlier times.

The Kolmogorov backward equation can be solved using differentiable quantum generative models with a time-dependent feature map, in a way that may be considered similar to PINN/DQC workflow. The differential loss may be based on the difference of the right-hand side and the left-hand side of the Kolmogorov backward equation, which may be referred to as the KBE differential operator KBE (p, x, τ; θ, g). The associated loss function [symbol] _{θ}^{evol} may be defined as

$${ℒ}_{θ}^{e v o l} = {\sum }_{x , τ ∈ 𝒥 \times 𝒳} 𝒟 [ 0 , KBE ( {\tilde{p}}_{θ} , x , τ ; f , g ) ] . \qquad ( 12 )$$

Once the model has been trained with such a loss function, the model can be sampled within the trained region, and generalized in between the discrete training points.

In order to solve the stochastic differential equations and/or partial differential equations in the manner explained above, it is necessary to differentiate the proposed model. This differentiation is not possible with many other architectures, such as quantum circuit Born machines and quantum generative adversarial networks. Advantageously, because the methods described in this disclosure are based on the phase feature map, x-derivatives of DQGM can be read out exactly, and more efficiently, by avoiding the parameter shift rule.

By construction, the latent space probability distribution p_{θ}(x) corresponds to a parametrized quantum circuit with feature map encoding, and can be analysed by studying associated Fourier series. In this example, the model capacity of the phase feature map [symbol] _{φ}(x) is analysed (while Chebyshev series are available with additional variable transformations, the phase map with homogeneous {ξ=1}ⱼ₌₁^{N} can be analysed in the Fourier space). In this disclosure, model capacity is defined as the number of modes (frequencies) that are in principle available in the model. This is determined by the spectral properties of the generator of the feature map, Ĝ: [symbol] (x)=exp (−ixĜ/2). Generally, parametrized quantum circuits can represent a function (i.e., a model) as

$${f}_{θ} ( x ) = {\sum }_{ω ∈ Ω} {c}_{ω , θ} {e}^{i ω x} , \qquad ( 13 )$$

where the spectrum of frequencies Ω represent all possible differences of eigenvalues of Ĝ, and c_{ω,θ} are θ-dependent coefficients associated with each frequency ω. Important properties of the spectrum are that it includes a zero frequency, pairs of equal-magnitude positive and negative frequencies, and coefficients that obey c_{ω}=c*_{-ω}, leading to real-valued models (as expected from an expectation value).

While the analysis could proceed by studying the generator of the phase map, in this case, the model capacity can be derived explicitly from the latent state written in Eq. (2). The phase for each qubit rotation may be defined as φⱼ:=2π(2ⱼξⱼ). As an N-qubit superposition state |\tilde{x} [symbol] has an equal overlap with all computational basis states, | [symbol] x|\tilde{x}|²=½^{N} ∀x ∈ [symbol] (where [symbol] is the set of bit strings with N bits), but each individual contribution comes with a different phase (sum of individual φⱼs). Expanding the tensor product in Eq. (2) it can be seen that the computational zero state |ø) has a zero phase.

Next, there are N states with single excitations, |j):=e^{jφjx}\hat{X}ⱼ|ø), each with a phase exponentially decreasing from the highest (φ₁=2π/2) to lowest (φ_{N}=2π/2^{N}) at increasing qubit number. Then, there are N (N−1)/2 states with double excitations, |jj′):=e^{i(φjφj′)x}\hat{X}ⱼ\hat{X}ⱼ′|ø), where the corresponding phase is a sum of contributions. In general, there are N!/m!(N−m)! states with m excitations (and sums of m phases), culminating with a fully excited state | [symbol] :=e^{iΦ}\hat{X}^{⊗N}|ø), with Φ=Σⱼφⱼ=2π(2^{N}−1)/2^{N}. The sum of phases associated to bit basis states {| [symbol] )} can be collected and will henceforth be referred to as frequencies { [symbol] }={2π [symbol] /2^{N} [symbol] . The latent state can then be rewritten in a simple form

$$\vert \tilde{x} 〉 = ( {e}^{- i Φ / 2} / {2}^{N / 2} ) {\sum }_{ℓ = 0}^{{2}^{N} - 1} {e}^{i {v}_{ℓ} x} \vert {x}_{ℓ} 〉 . \qquad ( 14 )$$

Based on these results, the model itself may be constructed as in Eq. (5), which comes from the overlap (squared) of the latent feature state with an ansatz-prepared state, [symbol] θ|ø [symbol] = [symbol] [symbol] [symbol] [symbol] (hereafter we simplify the notation by removing tildes where appropriate). The latent space probability distribution then reads

$${\tilde{p}}_{θ} ( x ) = \frac{1}{{2}^{N}} {\sum }_{ℓ , {ℓ}^{′} = 0}^{{2}^{N} - 1} {a}_{ℓ , θ}^{*} {a}_{{ℓ}^{′} , θ} {e}^{i ( {v}_{ℓ} - {v}_{{ℓ}^{′}} ) x} = \qquad ( 15 )$$

$$= \frac{1}{{2}^{N}} + \frac{1}{{2}^{N - 1}} {\sum }_{ℓ > {ℓ}^{′}} [ Re \{ {a}_{ℓ , θ}^{*} {a}_{{ℓ}^{′} , θ} \} cos [ ( {v}_{ℓ} - {v}_{{ℓ}^{′}} ) x ] - lm \{ {a}_{ℓ , θ}^{*} {a}_{{ℓ}^{′} , θ} \} sin [ ( {v}_{ℓ} - {v}_{{ℓ}^{′}} ) x ] ] ,$$

where in the second line the double sum has been split to show the real and imaginary parts of the θ-dependent density operator elements [symbol] [symbol] . Furthermore, the quantum state normalization has been accounted for.

As was stated above, the frequencies { [symbol] } are integer multiples of the smallest (‘base’) frequency 2π/2^{N} defined by the register size N. Looking at the differences of {v [symbol] - [symbol] , it can be seen that the model in Eq. (15) corresponds to Eq. (13) with ω ∈ Ω={0±1±2, . . . , ±(2^{N}−1)}×2π/2^{N}, where multiplicity for each frequency decreases as 2^{N}− [symbol] , [symbol] =0, 1, . . . , 2^{N}−1. Thus, it suffices to collect the associated coefficients C_{ω,θ} for each ω. Consequently, the spectral properties of the phase feature map, and of the associated latent model, establish its model capacity of exponential size with (2^{N}−1) non-zero frequencies,

Given the analysis above, the methods in this disclosure provide the following advantages related to successful training of quantum generative models:
1. While DGQM and QCBM both have O(2^{N}) model capacity, they have different model expressivity in terms of coefficients {_{ω, θ}}. As variational unitary circuits have limited depth due to trainability, the performance will widely vary depending on typically accessible model coefficients for the given ansatz. The exponential capacity can be then seen as a problem for certain distributions, as highly-oscillatoric terms will lead to overfitting and corrupt derivatives when solving differential equations.
2. In the latent space there is a clear separation between high and low frequency parts of the model, corresponding to qubits with small and large j. This suggest that DGQM can be trained to mostly adjust low frequency components while keeping high frequency components intact, and use the full register for sampling. This is the core of qubit-wise training described in the next subsection. Such an approach does not hold for QCBMs.
3. A family of models accessible by DQGM is that of trigonometric polynomials with exponentially many frequencies and constrained variationally-controlled coefficients. In cases where a smooth probability distribution is modelled, it may suffice to train only the low-frequency part of the register L<N chosen such that 2^{L}˜ poly (N). This allows for classical Fourier (cosine/sine) series to be used for probability distribution modelling and/or differential equation solving. The quantum model then requires an O(poly (N)) depth circuit as an instruction for creating the state p_{θ} that matches this series. In this case, the system can be initialised close to a predicted solution (performing Fourier series initialization), while still getting sampling advantage for the full register and using the variational state preparation only for inducing further correlations.
4. The structure of the phase map is quite exceptional—unlike product and tower feature maps, where phases of x-dependent rotations are either qubit-independent or have a prefactor of j, the phase feature map has ˜2^{-j} scaling. Thus, for the same capacity of the phase and product feature maps, the latter will have higher expressivity as more qubits and wider variational circuits are used. This may be exploited by employing a feature map sparsification technique-keeping the spectrum the same, but distributing coefficients over larger registers.

FIG. 7B shows an implementation of an inverted unitary on a quantum hardware device. In particular, FIG. 7B displays a table 720 in which a first column 722 describes a unitary evolution and a second column 724 describes the corresponding ‘daggered’ evolution. A dagger of a matrix or operator refers to its conjugate transpose, and for a unitary operator [symbol] , the conjugate transpose is by definition equal to its inverse, i.e., [symbol] ^{†}= [symbol] ⁻¹. A first row 726 describes the evolution from a quantum information theoretic perspective, while a second row 728 describes the evolution from a pulse-level perspective.

Thus, the unitary evolution can be considered, from a quantum information theoretic perspective, as a circuit 730 denoted by [symbol] _{θ}, which may be implemented as a sequence of pulses 734 denoted by exp (i \hat{X} ∫Ω(t)dt/2). A first pulse 738 of the sequence of pulses is shown in more detail. In this context, a pulse may refer to a signal used for controlling a qubit. Depending on the hardware used, it can be, e.g., an optical or electrical pulse.

The corresponding daggered evolution may then be considered as an ‘inverse’ circuit 732 denoted by [symbol] ^{†}_{θ}. This circuit may again be implemented as a sequence of pulses, where the properties of the pulses for the daggered evolution are based on the properties of the regular (undaggered) evolution. For a product of unitaries A and B, it is known that (AB)^{†}=B^{†}A^{†} (note the reverse order!). If A and B refer to individual pulses, this may be interpreted as that the order of the pulses should be reversed in time, and that each individual pulse should be daggered.

Thus, the daggered unitary can be implemented at a pulse-level using strategy: assuming the overall circuit unitary is composed of a sequence of operations implemented as pulses on a quantum device, the first step is to execute all these subsequent pulses in the reverse order due to the dagger property reversing the order of composite operators. Next, each of those pulses needs to be executed individually in their daggered form. Two strategies for doing so are provided. In general, the aim is to acquire a daggered phase that is the negative of the regular phase, such that the two unitaries would cancel out as [symbol] ^{\} [symbol] =I (where I represents the identity matrix). If the pulse is executed on a device with full control over the amplitude, both in positive or negative value, the sequence of pulses 734 can be applied in reverse order 736 and with a negative sign in front of the pulse amplitude, over the same time period; in that case, the daggered (or ‘inverted’) pulse may be denoted by exp (i \hat{X} ∫−Ω(t)dt/2).

However, not all hardware implementation allow for negative amplitudes, or there may be other reasons for not wanting to do it that way. Therefore, an alternative strategy is presented. Consider the single pulse 738. The aim is to construct an operation [symbol] such that [symbol] [symbol] =I, because that means [symbol] = [symbol] ^{†}. One option is to consider a total pulse 740 with phase 2π MINUS the original pulse's integrated area; in that case, the inverted (daggered) pulse may be denoted by exp (i \hat{X}(2π−∫Ω(t)dt)/2). Multiplied together, such [symbol] would give [symbol] [symbol] =I because the TT pulse by itself is already identity and I²=1. This strategy works because the overall pulse area of \tilde{Ω} is still positive, assuming the original pulse area of Ω in 738 was less than 2π.

In the embodiments below, several strategies are described that can be used for DGQM training. Specifically, knowledge of the latent space can be exploited to perform training in several stages and provide means of regularizing the trained generative models.

This may be referred to as frequency taming.

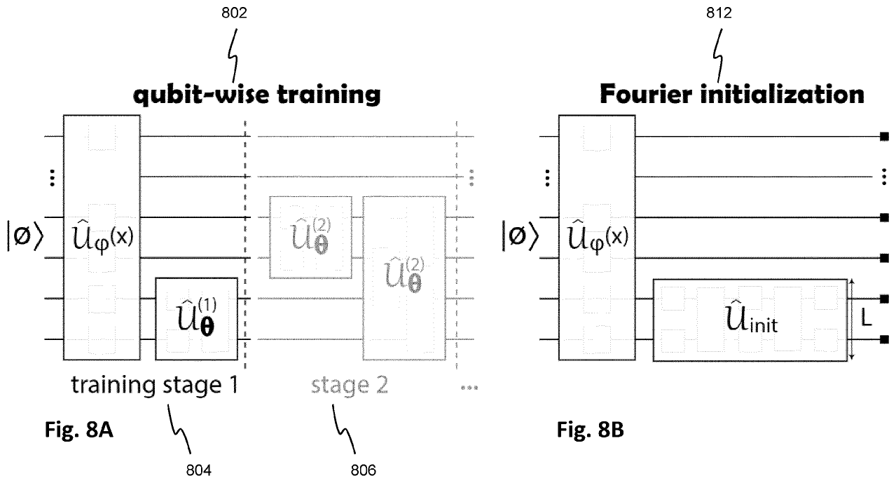

FIG. 8 schematically shows frequency-taming techniques according to an embodiment. In particular, FIG. 8A shows qubit-wise training 802, where a variational circuit is first trained to adjust a low frequency part of a model in a first stage 804. In the second stage 806, [symbol] _{θ}⁽¹⁾ is kept fixed, and higher frequency components are trained with [symbol] _{θ}⁽²⁾. The higher frequency components are then correlated the lower frequency register. This process may continue with ever higher frequencies until sufficient accuracy is achieved. The final optimization run is for the full circuit and register.

As a first frequency-taming technique for DQGM training, the ansatz may be split into lower and higher frequency parts. This may be referred to as qubit-wise learning, similarly to the layer-wise learning in classical and quantum machine learning. The procedure is schematically depicted in FIG. 8A, where training of the DQGM is divided into stages.

A first goal is to achieve correct base frequencies for the model, training qubits j=N, N−1, . . . , N−n (n«N). Next, quasi-optimal angles are saved for the first cycle of optimization, and proceed to include higher frequencies (qubits with smaller ∫). Subsequently, the registers may be correlated, e.g., with a tailored ansatz. Finally, when all quasi-optimal angles are found, training is performed for the full register. This approach will be demonstrated below in relation to numerical experiments.

FIG. 8B illustrates an example of Fourier initialization 812 according to an embodiment. First, a classical Fourier series is determined for a distribution of interest with 2^{L}−1˜poly (N) frequencies, and then an initialisation operator [symbol] ᵢₙᵢₜ (defined below in Eq. (16)) is used to prepare the corresponding state.

One of the common problems affecting machine learning models is initialization that leads to local minima, and prohibits finding high-quality models. Initialization with low-degree polynomial (truncated Chebyshev series) may vastly reduce number of optimization epochs. Here, the structure of the quantum model in Eq. (15) is used, and coefficients are matched for all frequencies ω ∈ Ω by preparing a suitable quantum state

$${\hat{𝒰}}_{init} \vert 0 {〉}^{⊗ L} = {\sum }_{ℓ = 0}^{{2}^{L} - 1} {a}_{ℓ , init} \vert {x}_{ℓ} 〉 \qquad ( 16 )$$

The preparation circuit can be exponentially deep in L, but preferably L is chosen such that L«N, using only poly (N) frequencies. Thus, this technique can advantageously be employed in cases where limited expressivity suffices, but fast sampling is needed for dataset augmentation—this is specifically relevant for multi-dimensional distributions.

As noted before, one of the desirable features when working with the feature map of exponential capacity is the possibility to control coefficients for different frequencies. For example, product feature maps have been shown to result in feature maps with better expressivity than serial feature maps, for the same model capacity. This is because in the product case, a single layer of rotations already gives independent control over multiple coefficients, unlike the serial case. For the phase feature map used in the methods in this disclosure, feature map rotations are concatenations of base frequency rotations, and no variational control of the model is allowed at that stage—to enable sampling, the feature map cannot be changed arbitrarily, as it is an integral part of the measurement circuit. This issue can be overcome by spreading the features over larger number of qubits, which may be referred to as feature map sparsification strategy.

Feature map sparsification relies on the fact that two circuits can be concatenated if an (adjusted) quantum gate teleportation circuit is used. In the following example, the x-basis is used for simplicity. As the spectrum of the models is the same, and given that Ĥ \hat{Z}=\hat{X} Ĥ, an extra layer of Hadamards can be appended to the transformation circuit [symbol] _{T}.

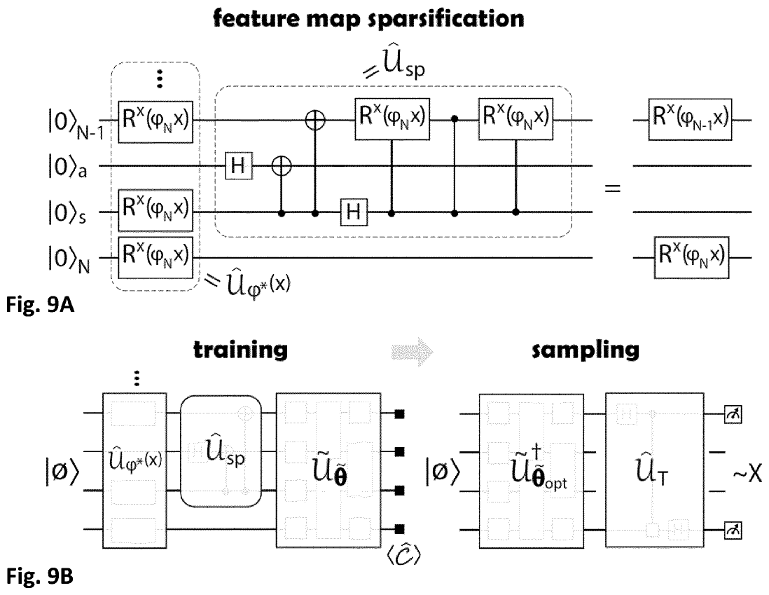

FIG. 9 schematically shows feature map sparsification according to an embodiment. In particular, FIG. 9A shows a (for—example) low-frequency part of the phase feature map, where the rotation gate from the seed qubit(s) is teleported to the register qubit N−1, which stores the second lowest frequency. Higher-frequency sparsifications can be constructed in a similar way, with varying split in frequencies (degree of sparsification).

Concentrating on the lowest frequencies, it can be observed that the second-to-last qubit in the feature map shall be in the \hat{R}^{x}(φ_{N-1}x)|0 [symbol] _{N-1} state, and φ_{N-1}=2φ_{N}. Thus, the same state can be prepared by adding two qubits as a seed with \hat{R}^{x}(φ_{N}x)|0 [symbol] ₛ state (labelled as s in FIG. 9A). Using a Bell state with an ancilla qubit, the state from the seed can be teleported to the register qubit, such that an additional \hat{R}ₓ(φ_{N}x) gate is applied. The process can be made deterministic if an x-dependent correction circuit is added. In this case, feature map sparsification is performed by unitary gate [symbol] ₛₚ, and the circuit identity in FIG. 9A holds.

FIG. 9B shows training and sampling stages for the sparsified phase map, where the variational circuit acts on all qubits including seeds and ancillas, while during sampling only the N-qubit register is transformed and measured. Again, only lowest frequencies are shown.

The feature map sparsification is used during the training stage, where all qubits (including ancillas and seeds) are trained to match the model—this does not change the frequencies, but increases expressivity. This can be shown using an analytical model, which can be derived for the simplest case. Subsequently, during the sampling stage, the trained model is used, but only qubits from the state register on which the transformation (inverse QFT) circuit acts are sampled.

FIGS. 10A and 10B show a schematic of a variational feedback loop for a DGQM-based quantum algorithmic subroutine. In particular, FIG. 10A shows that now the DQGM structure and optimization schedule are defined, several initialization steps need to be made 1004. We first need to specify a set of points {X} (a regular or a randomly-drawn grid) for each stochastic variable in the domain of interest 1006. The variational parameters θ are set to initial values (e.g. as random angles). The expectation value over variational quantum state for the cost function is estimated 1010, using the quantum hardware, for the chosen point xⱼ. Then a probability density function suggestion at this point is constructed. Next, the derivative quantum circuits are constructed 1011,1008 and their expectation value is estimated 1010 for the specified cost function, at point xⱼ. Repeating the procedure 1006 for all xⱼ in {X} function values and derivatives are collected, and the loss function for the entire grid and optional system of Fokker-Planck equations are composed (forming required polynomials and cross-terms by classical post-processing) as shown in 1012. The regularization points are also added, forcing the solution to take specific values at these points. The goal of the loss function is to assign a “score” to how well the potential solution (parametrized by the variational angles θ) satisfies the differential equation, matching derivative terms and the function polynomial to minimize the loss.

With the aim to increase the score (and decrease the loss function), also the gradient of the loss function 1012 may be computed with respect to variational parameters θ. Using the gradient descent procedure (or in principle any other classical optimization procedure 1014) the variational angles may be updated from iteration nⱼ=1 into the next one nⱼ+1 in step 1016, and the steps outlined before may be repeated until the exit condition is reached. The exit condition may be chosen as: 1) the maximal number of iterations nᵢₜₑᵣ reached; 2) loss function value is smaller than pre-specified value; and 3) loss gradient is smaller than a certain value. Once we exit the classical loop, the solution is chosen as a circuit with angles θₒₚₜ that minimize the loss. Finally, the full solution may be extracted by sampling the circuit shown in FIG. 7 at 710.

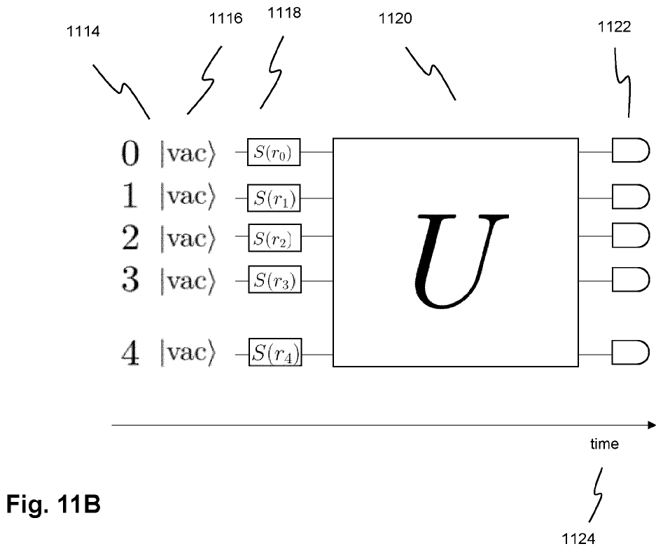

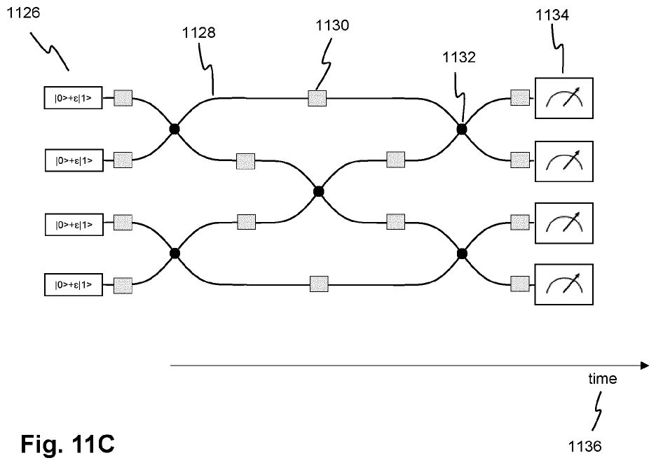

FIG. 11A is a hardware-level schematic of the actions effectuating the logical operations shown in circuit diagrams such as FIG. 7. The ansatz unitaries 702, the variational unitaries 706,716, and the transformation unitaries 712 can be decomposed into a sequence of logical gate operations. These logical gate operations are transformations in the quantum Hilbert space over the qubits. In order to transform the internal states of these qubits, a classical control stack may be used to send pulse information to a pulse controller that affects one or more qubits. The controller may send a sequence of such pulses in time and for each qubit independently. An initialization pulse is used to initialize the qubits into the |0 [symbol] state 1102. Then, for example, a series of single-qubit pulses 1104 is sent to the qubit array. This series of single-qubit pulses may apply a single-layer feature map. Two-qubit pulse sequences can be used to effectively entangle multiple qubits 1106. The duration, type, strength, and shape of these pulses determine the effectuated quantum logical operations. 1108 indicates a ‘break’ in the depicted timeline, which means that the sequence of gates may be repeated in a similar fashion in the direction of the time axis 1112. At the end of the pulse sequences, the qubits may be measured 1110.

FIG. 11B is a hardware-level schematic of the actions effectuating the logical operations shown in circuit diagrams such as FIG. 7, specified for a photonic/optical quantum processor. The ansatz unitaries 702, the variational unitaries 706,716, and the transformation unitaries 712 can be decomposed into a sequence of optical gate operations. These logical gate operations are transformations in the quantum Hilbert space over the optical modes. In order to transform the internal states of these modes, a classical control stack may be used to send pulse information to a pulse controller that affects one or more modes. The controller may formulate the programmable unitary transformations in a parameterized way.

Initially the modes 1114 are all in the vacuum state |vac [symbol] 1116, which are then squeezed to produce single-mode squeezed vacuum states 1118. The duration, type, strength and shape of controlled-optical gate transformations determine the effectuated quantum logical operations 1120.

At the end of the optical paths, the modes may be measured with, e.g., photon-number resolving, Fock-basis measurement 1122, tomography or threshold detectors.

FIG. 11C is a hardware-level schematic of the actions effectuating the logical operations shown in circuit diagrams such as FIG. 7, specified for a Gaussian boson sampling device. The ansatz unitaries 702, the variational unitaries 706,716, and the transformation unitaries 712 can be decomposed into a sequence of optical gate operations. These logical gate operations are transformations in the quantum Hilbert space over the optical modes. In order to transform the internal states of these modes, a classical control stack may be used to send information to optical switches and delay lines. The controller may formulate the programmable unitary transformations in a parameterized way.

Initially the modes 1126 are all in a weak coherent state, which mostly vacuum with a chance of one or two photons and negligibly so for higher counts. Then, the photons travel through optical waveguides 1128 through delay lines 1130 and two-mode couplers 1132 which can be tuned with a classical control stack, and which determines the effectuated quantum logical operations.

At the end of the optical paths, the modes may be measured with photon-number resolving 1134, or threshold detectors.

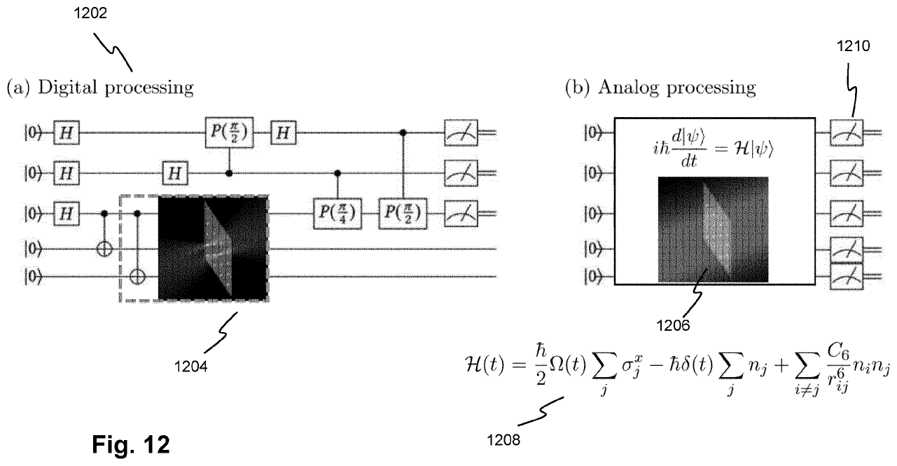

FIG. 12 is a hardware-level schematic of the actions effectuating the logical operations shown in circuit diagrams such as FIG. 7, specified for a neutral atom based quantum device. The ansatz and variational unitaries can be decomposed into two different kinds of operations on this hardware type: digital or analog. Both of these kinds of operations are transformations in the quantum Hilbert space over the atomic states.

In the digital mode, laser pulses are used to effectuate transitions between atomic states which effectively implement sets of standardized or ‘digital’ rotations on computational states. These digital gates include any single-qubit rotations, and a controlled-pauli-Z operation with arbitrary number of control qubits.

In the analog mode, laser light is applied to groups of, or all, atoms at the same time, with certain properties like detuning, Rabi frequencies and Rydberg interactions effectively driving Hamiltonian evolution of the atomic array in an analog way. The combined quantum wavefunction evolves according to Schrodinger's equation, and particular unitaries U=e^{-iHt} can be designed by pulse-shaping the parameterized coefficients of the Hamiltonian in time. This way, a parametric analog unitary block can be applied, which entangles the atoms and can act as a variational ansatz.

The digital and analog modes can be combined or alternated, to yield a combination of the effects of each.

In order to transform the internal states of these modes, a classical control stack can be used to send information to optical components and lasers. The controller may formulate the programmable unitary transformations in a parameterized way.

At the end of the unitary transformations, the states of the atoms are read out by applying measurement laser pulses, and then observing the brightness using a camera to spot which atomic qubit is turned ‘on’ or ‘off’, 1 or 0. This bit information across the array is then processed further according to embodiments of this invention.

As was explained above, the DQGM model can be characterised by

$${\tilde{p}}_{θ} ( x ) = tr \{ {\hat{𝒞}}_{∅} {\hat{U}}_{θ} {\hat{𝒰}}_{φ} ( x ) {\hat{ρ}}_{0} {\hat{U}}_{φ}^{†} ( x ) {\hat{𝒰}}_{θ}^{†} \} . \qquad ( 17 )$$

Thus, in order to differentiate the model with respect to x, the derivative d\tilde{p}_{θ}(x)/dx is preferably determined analytically. To this end, it may be observed that

$$\frac{d {\hat{𝒰}}_{φ} ( x )}{dx} = - i {\hat{M}}_{x} {\hat{𝒰}}_{φ} ( x ) , \qquad ( 18 )$$

wherein the operator \hat{M}ₓ:=ΣΣⱼ₌₁^{N}\hat{X}ⱼ/2^{j} is the generator of the phase map. This generator commutes trivially with the phase map, [\hat{M}ₓ, [symbol] _{φ}(x)]=0 ∀x. Although \hat{M}ₓ is non-unitary, it can still be applied to the computational zero as \hat{M}ₓ|ø [symbol] ∝Σⱼ₌₁^{N}| [symbol] /2^{j}, generating a ‘one-hot’ state with single excitation. A normalization prefactor [symbol] may be defined such that ( [symbol] ) \hat{M}ₓ|ø [symbol] is a valid quantum state. Furthermore, as was explained above, [symbol] _{ø}=\hat{p}₀.

Using these observations, the full model may be differentiated, resulting in

$$\frac{d {\tilde{p}}_{θ} ( x )}{dx} = i tr \{ {\hat{ρ}}_{0} {\hat{U}}_{θ} {\hat{𝒰}}_{φ} ( x ) {\hat{M}}_{x} {\hat{ρ}}_{0} {\hat{U}}_{φ}^{†} ( x ) {\hat{𝒰}}_{θ}^{†} \} - i tr \{ {\hat{ρ}}_{0} {\hat{U}}_{θ} {\hat{𝒰}}_{φ} ( x ) {\hat{ρ}}_{0} {\hat{M}}_{x} {\hat{U}}_{φ}^{†} ( x ) {\hat{𝒰}}_{θ}^{†} \} , \qquad ( 19 )$$

changing the order in which \hat{M}ₓ acts on \hat{p}₀. The corresponding measurement of two overlaps can be combined into the measurement of the expectation value

$$\frac{d {\tilde{p}}_{θ} ( x )}{dx} = tr \{ ( {δ}_{1} \hat{𝒞} ) {\hat{U}}_{θ} {\hat{𝒰}}_{φ} ( x ) {\hat{ρ}}_{0} {\hat{U}}_{φ}^{†} ( x ) {\hat{𝒰}}_{θ}^{†} \} , \qquad ( 20 )$$

where δ₁Ĉ defines a new differential cost operator δ₁Ĉ:=i\hat{M}ₓĈ_{ø}−iĈ_{ø}\hat{M}ₓ. This differential cost operator can be rewritten as

$${δ}_{1} \hat{𝒞} = π {\sum }_{j = 1}^{N} \frac{1}{{2}^{j}} {\hat{Y}}_{j} ⊗ \vert ∅ {〉}_{\overline{J}} 〈 ∅ \vert , \qquad ( 21 )$$

where the state |ø [symbol] [symbol] ø| means a computational zero state for the register of N−1 qubits, apart from the j^{th} one.

Thus, N evaluations of the expectation value are needed. This is an improvement over 2N evaluations for the parameter shift rule. Analysing the commutators in δ₁Ĉ that correspond to SWAP-like operators, this may possibly be further improved.

Similarly, a second-order derivative for the quantum probability distribution may be derived. To this end, the expression in Eq. (21) may be differentiated, so that d²\tilde{p}_{θ}(x)/dx² can be written as an expectation value

$$\frac{{d}^{2} {\tilde{p}}_{θ} ( x )}{{dx}^{2}} = tr \{ ( {δ}_{2} \hat{𝒞} ) {\hat{U}}_{θ} {\hat{𝒰}}_{φ} ( x ) {\hat{ρ}}_{0} {\hat{U}}_{φ}^{†} ( x ) {\hat{𝒰}}_{θ}^{†} \} , \qquad ( 22 )$$

where δ₂ [symbol] introduces another Hermitian operator

$${δ}_{2} \hat{𝒞} := 2 {\hat{M}}_{x} {\hat{𝒞}}_{∅} {\hat{M}}_{x} - {\hat{M}}_{x} {\hat{𝒞}}_{∅} - {\hat{𝒞}}_{∅} {\hat{M}}_{x} , \qquad ( 23 )$$

which can be decomposed into O(N²) non-commuting terms that can be measured separately.

In general, it is unlikely that sampling from a univariate distribution using a quantum computer gives a tangible advantage over using a classical computer. In the end, for most practical cases a finite-degree polynomial approximation can be used, for example—as commonly used in financial analysis. Yet, when working with multivariate (multidimensional) distributions, sampling becomes more complicated. There is therefore a need for solutions when working with a vector of stochastic variables X=(X₁, X₂, . . . , X_{d}) that becomes a d-dimensional vector (with d>1). The underlying probability distribution corresponds to p(x) with x=(x₁, x₂, . . . , x_{d}), and often, it is convenient to work with a multivariate cumulative distribution function F (x). If the distributions are not correlated, inverse sampling may be performed, assuming that the multivariate CDF factorizes into a product of marginal distributions, Fₛᵢₘₚₗₑ(x)=F₁(x₁)·F₂(x₂) . . . . F_{d}(x_{d}), and the same is true for the probability density function. This means, even though multivariate distributions are being considered, the cost is effectively similar to that of univariate case and an advantage of quantum computing is unlikely.

However, for correlated variables this ‘decoupling’ procedure is not valid. For example, imagine a bivariate distribution such that two stochastic variables X₁ and X₂ are distributed normally, but are in fact correlated. The correlation for normal distributions can be accounted for using a correlation matrix, which grows with the dimension d. Thus, accounting for correlations becomes challenging for generied-dimensional distributions. However, this problem can be resolved by introducing a copula—a function that links marginal distributions of different variables. Copulas absorb correlations between variables while being agnostic to the types of distributions. Specifically, following the Sklar's theorem, a copula C [v] acting on some vector v may be written as a function

$$F ( x ) = C [ {F}_{1} ( {x}_{1} ) , {F}_{2} ( {x}_{2} ) , … , {F}_{d} ( {x}_{d} ) ] , \qquad ( 24 )$$

which links marginals into a full multivariate CDF. Similarly, a copula density function c [x] can be written as

$$c [ x ] = c [ {F}_{1} ( {x}_{1} ) , … , {F}_{d} ( {x}_{d} ) ] {p}_{1} ( {x}_{1} ) \cdot … {p}_{d} ( {x}_{d} ) . \qquad ( 25 )$$

The useful property of copulas is that by generating a vector of samples from the copula as U=(U₁, U₂, . . . , U_{d})˜C, they can be transformed into samples of the original multivariate distribution as

$$X = ( {Q}_{1} ( {U}_{1} ) , {Q}_{2} ( {U}_{2} ) , … , {Q}_{d} ( {U}_{d} ) ) , \qquad ( 26 )$$

where Qⱼ(Uⱼ) are marginal quantile functions (inverted CDFs) for distributions of a j^{th} component.

A way for including correlations between stochastic variables can be provided by quantum hardware, as quantum systems are good at correlating subsystems. Generative modelling may benefit from correlation, and specifically entanglement. This may use, for example, a joint register for the vector of variables x. However, for, e.g., QCBM-type problems, the enlarged size can become problematic as the training for large d can become prohibitive.

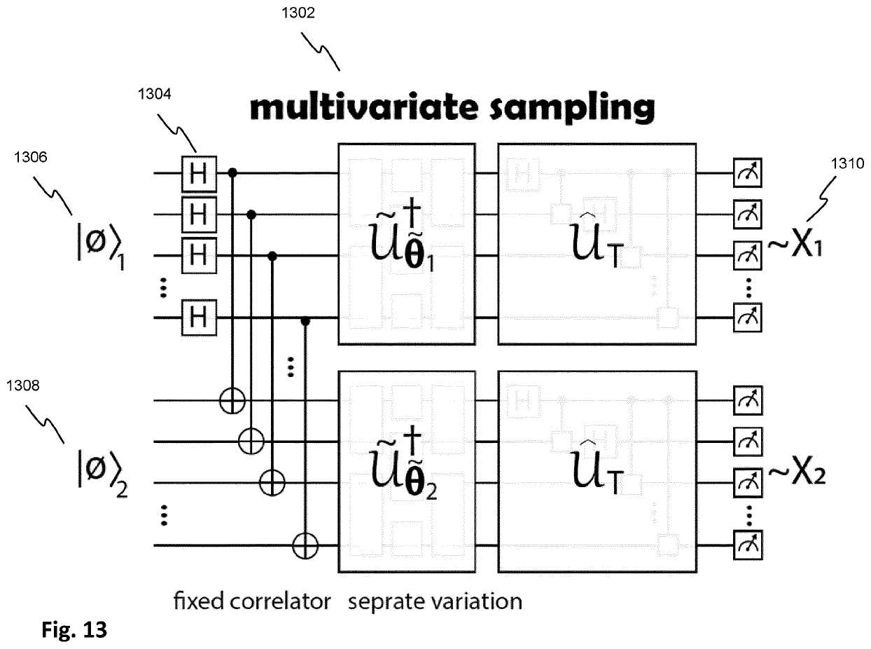

A more subtle way corresponds to including correlations by encoding copulas into a quantum hardware. A copula is a multivariate cumulative distribution function for which the marginal probability distribution of each variable is uniform on the interval [0, 1]. Since the copulas model only correlations, while having flat marginals, they can be modelled by entangled states. For example, the correlations can be introduced as a quantum circuit of finite depth that is applied prior to separate variational registers (see FIG. 13). Yet, when K registers are linked, even for tractable N-wide individual distributions, K·N qubits are needed that are maximally entangled in the logical sense. As a cluster state is formed, this requires the bond dimension to go up, and at certain point even tensor train decomposition will not be efficient. This is the setting in which we expect to get an advantage in quantum generative modelling.

FIG. 13 shows a schematic depiction of a quantum circuit used to represent a quantum copula as DQGM for multivariate sampling 1302. Separate registers for each dimension 1306,1308 are allocated. Entanglement between the registers is enabled 1304 to induce quantum correlations between the stochastic variables. Sampling at the output leads to correlated samples 1310 as desired.

The method is further illustrated with reference to the following numerical experiments. For these experiments, an Ornstein-Uhlenbeck process was chosen as an underling model. The Ornstein-Uhlenbeck process is a relatively simple stochastic process that lies at the core of many physical and financial models. For example, being a starting point for the Hull-White and Vasicek models, it is used for currency exchange rate modelling, and it represents a commonly used model for benchmarking quantum algorithms.

First, the application of the method on learning a static distribution is shown, together with benchmark frequency-taming techniques. Second, differential constraints are introduced and the steady-state Fokker-Planck equation is solved for the Ornstein-Uhlenbeck process. Third, the learnt solution is evolved in time, specifically solving the Kolmogorov backward equation for the Ornstein-Uhlenbeck process.

A normal distribution is represented and sampled by a DQGM circuit and, for comparison, by a by QCBM circuit. A target distribution corresponding to a normal process is selected (of which the Ornstein-Uhlenbeck process is an example). The corresponding probability density function (PDF) reads

$${p}_{target} ( x ) = \frac{1}{\sqrt{2 π {σ}_{O}^{2}}} exp [ - \frac{{( x - {μ}_{O} )}^{2}}{2 {σ}_{O}^{2}} ] , \qquad ( 27 )$$

where μ₀ is a mean and σ₀² is a variance. To load the probability density function in a quantum register, parameters shall be chosen such that the probability density function matches the probability distribution; that is, μ and σ should be chosen such that the probability distribution can be stored in a register with x ∈ [0,2^{N}−1) and 0≤p(x)≤1. In these examples, a mean square error (MSE) is chosen as the loss metric, which is normalized by the number of samples at which distributions are compared. As a testing ansatz, a hardware efficient ansatz (HEA) with alternating [symbol] [symbol] (2) rotations and entangling layers is used. Variation is performed using a gradient-based Adam optimizer, and Julia's Yao package is used as a simulator.

To showcase the peculiarities of DQGM and QCBM training, a system with N=4 registers is used. To understand the capabilities for learning a suitable generative model (probability distribution), the mean μ is fixed to the middle of the interval and the standard variation σ is set to σ=3. The DQGM is trained on [symbol] with 161 equally distributed points, until convergence, using corresponding probabilities. The QCBM is trained for all digital points, and the figures show plots using the full model based on the generalized QCBM distribution.

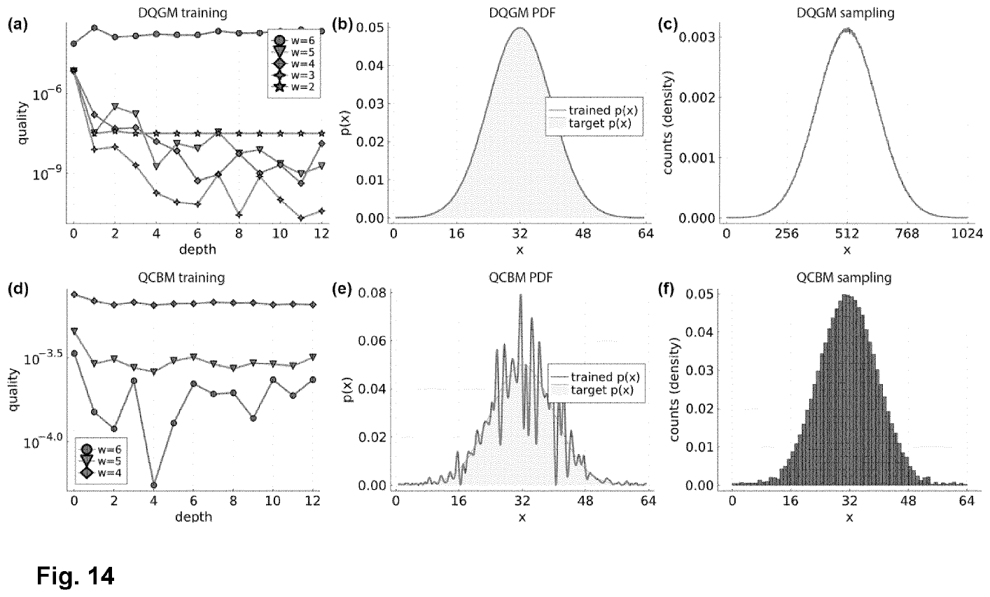

We start by considering a target distribution with N=6 qubits. We set the mean to 32 and the standard deviation of sigma_0=8. The training grid is set up to include all integer points of x, and use a thousand of epochs. The training is performed for varying depth and width. We test the performance of both DQGM and generalized QCBM for modelling the target as well as providing samples. As a metric, we plot the quality of solution, being the MSE loss evaluated for twenty times more points. The results are show in FIG. 14 In FIG. 14a we show the quality of solution for DQGM in the end of training. We observe that at full width training the model contains an exponential number of frequencies, limiting the performance due to large ‘out-of-sample’ error. At the same time, for smaller width we can capture the target distribution using lower frequency components, and reach high quality solutions. While the performance is likely to be model dependent, we observe that the optimal solution requires choosing a suitable combination of circuit width w and depth d. As an example of trained PDF we pick d=4 and highest-performing width of w=3. The trained DQGM closely follows the target model at all points (see FIG. 14b). We then apply the basis transformation and sample our model with the extended register of M=10 qubits. The histogram is shown in FIG. 14c where 10\hat{ }7 shots are used, and we normalize bins over the total number of samples.

Next, for comparison we consider the performance of generalized QCBM for the same problem. The results for d and w scanning are depicted in FIG. 14d. As encoding assumes transformations on bitstrings, smaller w circuits do not perform well, and w=N is required, as expected. We note that the presence of high frequencies in the model and absence of generalization that limits high frequency components generally impacts the QCBM's performance. The instance with the best quality is shown in FIG. 14e. While overall shape represents the distribution well, high-frequency component impact the model quality as it does not generalize. For instance, the impact on solving differential equations based on such a model will be tremendous. This can traced directly to the exponential capacity of the phase feature map, and the absence of simple frequency-taming. One option for regularization here is including more points during training, but this comes at the price of training at dense grids. Finally, we show the sampling from generalized QCBM in FIG. 14f. The histogram qualitatively matches with the target, as requested by optimization loss.

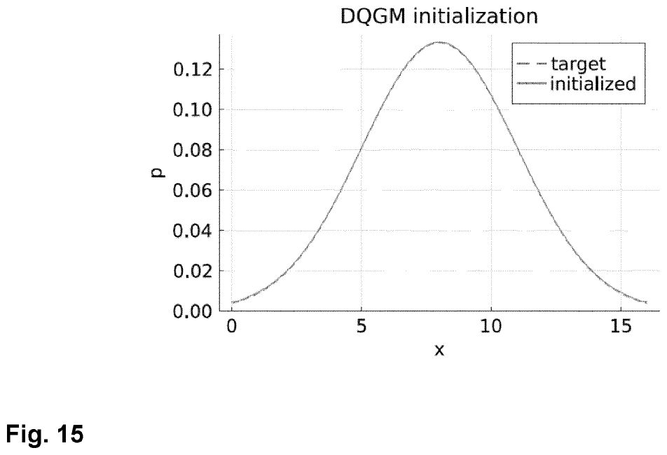

Following the use of the variational approach, we have also implemented the initialization procedure. In this case the target distribution is expanded in cosine series for 4 qubits, such that the coefficients of the preparation state are known. Using a SO (2\hat{ }4) circuit that can create an arbitrary real-amplitude state, we efficiently utilize all frequencies. The resulting PDF is shown in FIG. 15 We note that initialization may be required in cases where we want to off-load part of job from the variational procedure.

We proceed introducing the differential constraints, where together with learning from data by minimizing [symbol] _{θ}^{data}, we wish to minimize [symbol] _{θ}^{data} coming from the FPE differential operator. While the data-based learning does not require knowing the model parameters per se, the SDE/PDE/ODE learning does depend on the model parameters introduced by the drift and diffusion terms. We again choose the Ornstein-Uhlenbeck process as it lies at the core of many financial models. SDE of the OU process corresponds to static drift and diffusion terms, and reads

$${dX}_{t} = - v ( {X}_{t} - μ ) dt + σ {dW}_{t} , \qquad ( 28 )$$

where μ, σ, and ν are model parameters, which can be discovered while learning from data. Using Eq. (9) we can see that at the steady state Fokker-Planck equation for the Ornstein-Uhlenbeck process corresponds to

$$v p ( x , {t}_{s} ) + v ( x - μ ) \frac{d}{dx} p ( x , {t}_{s} ) + \frac{{σ}^{2}}{2} \frac{{d}^{2}}{{dx}^{2}} p ( x , {t}_{s} ) = 0. \qquad ( 29 )$$

Notably, when starting from some initial mean, this procedure results in μ as a new mean in the steady state (at the rate of ν), and a variance σ²/ν. It is convenient to set ν=1, assuming that time is in units of ν⁻¹.

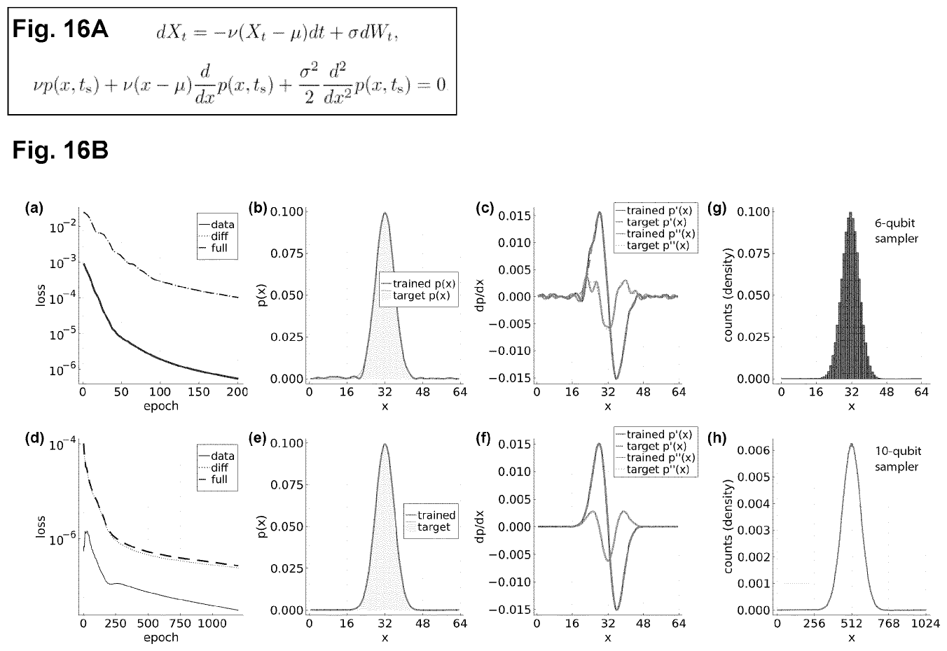

FIG. 16A shows the specific form of a stochastic differential equation known as the Ornstein-Uhlenbeck process (defined in eq. (28) above), and the stationary Fokker-Planck equation (defined in eq. (29) above) that is associated with the time-dependent Ornstein-Uhlenbeck.

The Ornstein-Uhlenbeck process with differential constraints may be solved using the following method steps. In this example, the Ornstein-Uhlenbeck parameters μ=8 and σ=\sqrt{2} are used. A N=4 qubit register is used for training the latent model, and a full Nₛ=8 register is used for the refined quantum sampling. The ansatz is the HEA with d=4, w=N, and 81 points are used for training. Initially, the loss is biased towards a data-based contribution, where DQGM aims to learn initial conditions. We use Adam for 1250 epochs at learning rate of 0.005 (a random seed is 12345).

FIG. 16B shows numerical results showing the effect of using differential constraints while training the DQGM for the Ornstein-Uhlenbeck process. In particular, FIG. 16B (a)-(c) show results where the DQGM is trained only on data, while in FIG. 16B (a)-(c), the DQGM is trained additionally on the stationary FPE differential constraint. FIG. 16B (a) show the history of data training, including the data loss (used for optimization), differential loss and the full weighted loss (plotted for scoring). Notably, using these choices, DQGM learns well to reproduce the required distribution, but does not capture the second-order derivative for the model.

This can be solved by including the differential constraints. Another stage of 1250 epochs (learning rate 0.002) leads to a marked improvement of the differential loss [symbol] _{θ}_{ₒₚₜ}^{diff} FIG. 16B (d) shows the history for the full loss training with differential constraints, where the full weighted loss is used for optimization, and the other two loss functions are plotted for scoring.

FIG. 16B (b), (e) respectively show the DQGM, probability density function evaluated, trained with only data and with additional differential constraint. FIG. 16B (c), (f) respectively show the derivative of the DQGM, trained with only data and with additional differential constraint. While the model may slightly deviate, visually, from the ideal normal shape [FIG. 16B (c)], the trained latent distribution \tilde{p}_{θ}_{ₒₚₜ}(x, tₛ) has derivatives that are close to the sought ones [FIG. 16B (d)], meaning that we faithfully reproduce the physics of the Ornstein-Uhlenbeck process, and not merely fit data. This point is important for further propagation.

FIG. 16B (g), (h) show the resulting sampling histograms, applying the basis transformation and projective measurements on the trained register N=4 (10⁶ samples), and extending it to Nₛ=8 qubits (10⁷ samples), respectively. The latter shows the power of the method according to this disclosure as a high quality distribution can be obtained, matching also the tails of Ornstein-Uhlenbeck distribution well.

Once the initial state is learnt and differential constraints are accounted for, the model may be used to predict the trajectories of the stochastic process that lead to the steady state.

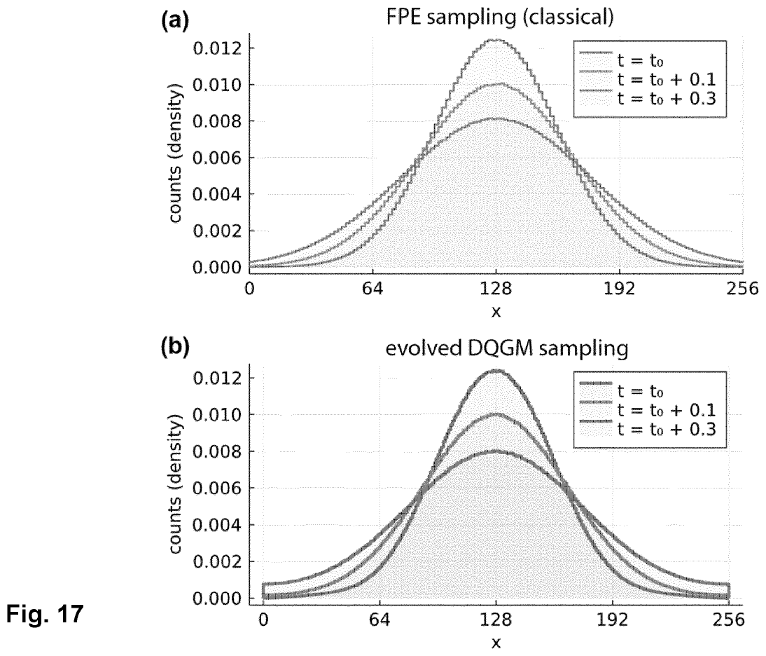

FIG. 17a shows a comparison between classical Euler-Maruyama solving of the FPE compared to using DQGM in FIG. 17b

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for sampling a generative model associated with a probability density function, PDF, in one or more dimensions, the probability density function being parameterized by a possibly higher-dimensional variable using a hybrid data processing system comprising a classical computer and a quantum processor, the method comprising:
receiving or determining, by the classical computer, a trained quantum neural network, QNN, the trained QNN being describable by a feature map for encoding the variable and a first parameterized quantum circuit, the trained QNN modelling the probability density function; and
executing, by the classical computer, a sampling process, the sampling process including generating, by the quantum processor, samples based on the modelled probability density function, the generation of samples comprising:
preparing the quantum register of the quantum processor in an initial state;
applying a second parameterized quantum circuit to the quantum register, the second parameterized quantum circuit comprising an inverse of the first parametrized quantum circuit of the trained QNN;
applying a unitary transformation, associated with the feature map, and
measuring the quantum register in a computational basis associated with the feature map, yielding bitstrings as measurement results, each bitstring representing a sample based on the modelled probability density function.

2. The method according to claim 1, wherein determining the trained QNN comprises:
receiving, by the classical computer, a set of information about a distribution function associated with the probability density function, the set of information including measurements of a stochastic process and/or an explicit or implicit functional description of the distribution function; and
executing, by the classical computer, a training process for training the QNN using training data based on the set of information and a loss function, the training process comprising execution of the QNN by the quantum processor, the execution of the QNN comprising:
preparing a quantum register of the quantum processor in the initial state;
applying a quantum circuit defining the quantum feature map to the quantum register;
applying the first parameterized quantum circuit to the quantum register, the first parameterized quantum circuit being associated with variational parameters; and
measuring a cost function value on the quantum register, the cost function value representing the output of the QNN.

3. The method according to claim 1 wherein the probability density function is associated with a distribution function describing outcomes of a stochastic process modelled by a Stochastic Differential Equation, SDE, in one or more dimensions.

4. The method according to claim 2 wherein the training process includes:
minimizing the loss function on the basis of a measured expectation value of the cost function by variationally tuning the variational parameters and repeating execution of quantum gate operations associated with the QNN and measurement of the output of the quantum processor as an expectation value of the cost function until convergence criteria are met.

5. The method according to claim 2 wherein the training process includes:
receiving or determining, by the classical computer, a formulation of quantum circuits representing the probability density function;
executing, by the quantum processor, the QNN for a set of points in the variable space of the probability density function;
receiving, by the classical computer, in response to the execution of the QNN, quantum hardware measurement data; and,
determining, by the classical computer, based on the quantum hardware measurement data and the loss function, if the quantum hardware measurement data form an accurate representation of the probability density function, given the set of information.

6. The method according to claim 5 wherein the QNN is parametrized by at least one continuous-variable associated with the stochastic process through the probability density function, and the QNN includes one or more function circuits for determining one or more trial functions values around one more points and one or more differential function circuits for determining one or more trial derivative values around the one or more points.

7. The method according to claim 5 wherein the training process includes solving a stationary or non-stationary Fokker-Planck equation, FPE, associated with the stochastic process, based on differentiable quantum circuits, DQCs, the differentiable quantum circuits including a first feature map quantum circuit which is a function of a differentiable variable of the FPE, and a quantum circuit representing a variational ansatz.

8. The method according to claim 7 wherein the determining if the quantum hardware measurement data forms a representative description of the probability density function is further based on one or more differential constraints associated with one or more SDEs, boundary conditions or probability density function properties.

9. The method according to claim 5 wherein executing the quantum circuits includes: translating each of the quantum circuits into a sequence of signals and using the sequence of signals to operate qubits of the quantum processor; and/or, wherein receiving hardware measurement data includes: applying a read-out signal to qubits of the quantum processor and in response to the read-out signal measuring quantum hardware measurement data.

10. The method according to claim 1 wherein the first parametrized quantum circuit is executable by the quantum processor using a generation of a first sequence of pulses, each pulse in the first sequence of pulses having an amplitude and a phase, and
wherein execution of the inverse of the first parametrized quantum circuit by the quantum processor comprises generation of a second sequence of pulses, the second sequence of pulses being obtainable by time-reversing the first sequence of pulses and inverting the amplitude or phase of the pulses.

11. The method according to claim 1 wherein the quantum processor executing the quantum neural network for modelling the probability density function includes a gate-based qubit device, a digital/analog quantum device, a neutral-atom-based quantum device, an optical qubit device, and/or a gaussian boson sampling device.

12. The method according to claim 1 wherein the sampling process includes: formulating a sampling circuit based on the trained parameters and the second parametrized quantum circuit; the sampling circuit being executed on the quantum processor for generating samples in the computational basis.

13. The method according to claim 2, wherein the training process and sampling process are executed in different operational modes on the same quantum processor; or, are executed separately on distinct quantum processors.

14. The method according to claim 1, wherein probability density function is associated with a stochastic process, the stochastic process involving one or more than one stochastic variables; and wherein one or more quantum feature maps are used to map each stochastic variable to a quantum latent state space in the training process, and to distinct quantum registers in the sampling process.

15. The method according to claim 1 wherein frequency taming and loading techniques are applied in a latent space representation of the probability density function on the quantum circuits; the frequency taming techniques including one or more of the following components: qubit-wise learning, Fourier initialization, feature map sparsification, and multidimensional correlation.

16. The method according to claim 1 wherein the feature map is differentiated using circuit differentiation rules, including parameter shift rules.

17. The method according to claim 1 wherein the trained QNN is maximized in an extremal-learning setting.

18. A method for determining an inverse of a function using a hybrid data processing system comprising a classical computer and a quantum processor, the method comprising:
receiving or determining, by the classical computer, a first plurality of quantum circuits associated with the function, the first plurality of quantum circuits comprising a first quantum circuit for encoding an input variable and a second quantum circuit for encoding an output value associated with the input value, wherein an output value of the function is obtainable by execution of the first plurality of quantum circuits by the quantum processor, the execution comprising:
preparing a quantum register of the quantum processor in an initial state;
applying the first quantum circuit to the quantum register;
applying the second quantum circuit to the quantum register; and
measuring a cost function value on the quantum register, the cost function value representing the output of the function; and,
determining, by the classical computer, a second plurality of quantum circuits associated with the inverse of the function, execution of the second plurality of quantum circuits by the quantum processor comprising:
preparing the quantum register of the quantum processor in the initial state;
applying a third quantum circuit to the quantum register, the third quantum circuit comprising an inverse of the second quantum circuit;
applying a unitary transformation, associated with the first quantum circuit, and
measuring the quantum register in a computational basis associated with the feature map, yielding bitstrings as measurement results, each bitstring representing an output of the inverted function.

19. A system for sampling a generative model associated with a probability density function, PDF, in one or more dimensions, the probability density function being parameterized by a possibly higher-dimensional variable using a hybrid data processing system comprising a classical computer system and a quantum processor, wherein the system is configured to perform the steps of:
receiving or determining, by the classical computer, a trained quantum neural network, QNN, the trained QNN being describable by a feature map for encoding the variable and a first parameterized quantum circuit, the trained QNN modelling the probability density function; and
executing, by the classical computer, a sampling process, the sampling process including generating, by the quantum processor, samples based on the modelled probability density function, the generation of samples comprising:
preparing the quantum register of the quantum processor in an initial state;
applying a second parameterized quantum circuit to the quantum register, the second parameterized quantum circuit comprising an inverse of the first parametrized quantum circuit of the trained QNN;
applying a unitary transformation associated with the feature map, and
measuring the quantum register in a computational basis associated with the feature map, yielding bitstrings as measurement results, each bitstring representing a sample based on the modelled probability density function.

20. The system according to claim 19, wherein the system is configured to determine the trained QNN and wherein determining the trained QNN comprises:
receiving, by the classical computer, a set of information about a distribution function associated with the probability density function, the set of information including measurements of a stochastic process and/or an explicit or implicit functional description of the distribution function; and
executing, by the classical computer, a training process for training the QNN using training data based on the set of information and a loss function, the training process comprising execution of the QNN by the quantum processor, the execution of the QNN comprising:
preparing a quantum register of the quantum processor in the initial state;
applying a quantum circuit defining the quantum feature map to the quantum register;
applying the first parameterized quantum circuit to the quantum register, the first parameterized quantum circuit being associated with variational parameters; and
measuring a cost function value on the quantum register, the cost function value representing the output of the QNN.

21. A system for training a generative model associated with a probability density function, PDF, in one or more dimensions, the probability density function being parameterized by a possibly higher-dimensional variable using a hybrid data processing system comprising a classical computer system and a quantum processor, wherein the system is configured to perform the steps of:
receiving, by the classical computer, a set of information about a distribution function associated with a probability density function, the set of information including measurements of a stochastic process and/or an explicit or implicit functional description of the distribution function; and
executing, by the classical computer, a training process for training a QNN using training data based on the set of information and a loss function, the training process comprising execution of the QNN by the quantum processor, the execution of the QNN comprising:
preparing a quantum register of the quantum processor in the initial state;
applying a quantum circuit defining a quantum feature map for encoding the variable to the quantum register;
applying the first parameterized quantum circuit to the quantum register, the first parameterized quantum circuit being associated with variational parameters; and
measuring a cost function value on the quantum register, the cost function value representing the output of the QNN.

22. A system for training and/or sampling from a generative model using a hybrid data processing system comprising a classical computer system and a special purpose processor, wherein the system is configured to perform any of the steps according to claim 1.

23. A computer program or suite of computer programs comprising at least one software code portion or a computer program product storing at least one software code portion, the software code portion, when run on a hybrid data processing system comprising a classical computer system and a quantum processor, being configured for executing the method steps according to claim 1.
